(19) United States
(12) Patent Application Publication
(10) Pub. No.: US 2015/0031790 A1
(43) Pub. Date: Jan. 29, 2015

(54) MICROGEL-CONTAINING TREAD MIXTURE FOR WINTER TYRES

(71) Applicant: LANXESS Deutschland GmbH, Cologne (DE)

(72) Inventors: Werner Obrecht, Moers (DE); Lothar Steger, Munich (DE)

(21) Appl. No.: 14/376,703

(22) PCT Filed: Feb. 11, 2013
(86) PCT No.: PCT/EP2013/052694

§ 371 Date: Aug. 5, 2014

(30) Foreign Application Priority Data
Feb. 10, 2012 (EP) 12154896.0

(51) Int. Cl. C08L 9/06; C08L 7/00

(52) U.S. Cl. CPC C08L 9/06; C08L 7/00; C08L 2205/02; C08L 2205/03
USPC 523/156

(57) ABSTRACT

The present invention relates to vulcanizable rubber mixtures comprising at least the following components:
I.) 100 parts by weight of an oil-free rubber matrix consisting of
   a) 15 to 79 parts by weight, preferably 20 to 70 parts by weight, of at least one solution SBR (S-SBR) (oil-free) having a glass transition temperature (Tg_{(S-SBR)}) between −70° C. and −10° C.,
   b) 20 to 75 parts by weight, preferably 25 to 70 parts by weight, of at least one 1,4-cis-polybutadiene (BR) (oil-free) having a glass transition temperature (Tg_{(BR)}) between −95° C. and −115° C.,
   c) 1 to 37.5 parts by weight, preferably 5 to 35 parts by weight, of natural rubber (NR) (oil-free) and/or at least one synthetic polyisoprene (IR) having a glass transition temperature (Tg_{(NR)}) between −50° C. and −75° C. based on the oil-free natural rubber (NR) or the oil-free, synthetic polyisoprene (IR),
II.) at least one hydroxyl-containing microgel based on polybutadiene,
III.) at least one hydroxyl-containing, oxidic filler,
IV.) at least one polysulphide-containing alkoxysilane,
V.) at least one vulcanizing agent,
VI.) optionally at least one rubber additive.

The present invention relates to vulcanizable rubber mixtures and to vulcanizates produced therefrom which are suitable for the production of studless treads for winter tyres.

Studs are pins made from steel or hard metal which are incorporated by vulcanization into the tread of winter tyres. They project from the surface of the tread and ensure better tyre adhesion on icy or snow-covered roads. However, they can damage the road surface in the course of thawing or when roads are free of snow, and so the use of such winter tyres in many countries is completely banned or permitted only under particular conditions.

As a result of the ban on studded winter tyres in many European countries and also in Japan, both the design of tread profiles for winter tyres and the optimization of rubber mixtures for winter tyres have gained significance. However, in spite of all efforts, the state of the art reached to date is still unsatisfactory, especially since tyre treads with good grip on ice and snow have shortcomings in the reversion resistance of the rubber mixtures and/or in rolling resistance and/or in abrasion resistance.

The prior art includes the following property rights concerned exclusively with the design of tread profiles for winter tyres: WO 2009/077231 A1, WO 2009/059849 A1, WO 2011/0365440, WO 2010/136989 A1 and EP 1 088 685 A1.

The applications which follow discuss rubber mixtures for winter tyres. DE 24 47 614 describes tread mixtures which consist of polybutadiene or of polybutadiene in combination with a synthetic rubber and/or with natural rubber. The fillers used are silica or silica and carbon black. The silica is activated with a bis[alkoxysilylalkyl] oligosulphide. The tyre treads obtained here feature an improvement in braking and acceleration characteristics on ice compared to carbon black-filled tyre treads. However, the ratio of synthetic rubber to natural rubber is unspecified.

DE 10 2009 033 611 A1 describes mixtures for winter tyres which have high reversion resistance, good braking power and high control stability on ice and snow, and high abrasion resistance. For the production of the rubber mixtures, natural rubber or polyisoprene rubber are used in combination with polybutadiene. The fillers used are mixtures of carbon black and silica in combination with standard silane couplers and zinc oxide whiskers in amounts of 0.3 to 30 parts by weight, particular limits being observed for the needle fibre length and the needle fibre diameter of the zinc oxide whiskers. To achieve the positive vulcanizate properties, it is important to conduct the vulcanization with unusually small amounts of sulphur of 0.5 to 0.75 part by weight based on 100 parts by weight of the rubbers.

The use of what are called microgels or rubber gels in rubber mixtures which are used for the production of various tyre components and tyre treads is also known.

EP 0 575 851 A1 describes rubber mixtures and vulcanizates which comprise a microgel based on polybutadiene without functional groups. The vulcanizates are notable for low hysteresis losses and high abrasion resistance. There are no examples in which the rubber matrix used is a combination of NR/BR/SBR, silicas and silane coupling agents. EP 0 575 851 A1 does point out that the mixtures are suitable for the production of tyres, but there is no specific teaching for the use of the mixtures as treads for winter tyres.

EP 1 063 259 A1 teaches the production of microgel-containing rubber mixtures and vulcanizates produced therefrom using sulphur-containing organosilicon compounds. The addition of sulphur-containing organosilicon compounds to the microgel-containing rubber mixtures achieves an improvement in the mechanical properties and in the DIN abrasion resistance without a deterioration in the rolling resistance/wet skidding resistance relation of tread compounds. It is indeed pointed out therein that the mixtures are suitable for the production of tyres and especially of tyre treads, but there is a lack of specific pointers for the configuration of the rubber mixtures with regard to the production of winter tyre treads.

U.S. Pat. No. 6,809,146 teaches the production of carbon black- and silica-filled rubber mixtures based on solution SBR, it being possible to use NR or IR and BR in addition to the S-SBR. The silica used in the rubber mixture is partly replaced by 0.1 to 5% by weight of a microgel based on BR, SBR, NBR etc., and the microgel may also contain functional groups such as hydroxyl, carboxyl, amino, diethylamino, vinylpyridine, chloromethylphenyl or epoxy groups. In addition to the silica, a silane is used. In the examples, exclusively mixtures of S-SBR and NdBR are used, with use of BR microgels without functional groups and hydroxyl-containing SBR microgels. However, there is a lack here too of specific pointers for the configuration of rubber mixtures with regard to the production of winter tyre treads.

According to the teaching of EP 2 311 907 A1, in silica-filled mixtures of rubbers which contain double bonds and also contain a hydroxyl-containing microgel and a polysulphide-containing alkoxysilane, allergenic guanidines are replaced by polythiophosphorus compounds. The mixtures have high processing reliability and good vulcanization characteristics. After the vulcanization, the vulcanizates exhibit good mechanical and physical properties combined with high crosslinking density. The mixtures are used for the production of tyres and for various tyre components. In the examples, mixtures of S-SBR and BR are used. In addition, there is no teaching therein as to the ratios in which BR, S—SBR and NR or IR should be used in order to achieve good properties as treads for winter tyres.

EP 1 935 668 A1 describes a pneumatic tyre whose sidewall consists of a rubber mixture of natural rubber and polybutadiene rubber. The rubber mixture also comprises silica and a rubber gel which, in a preferred embodiment, consists of polybutadiene and optionally contains functional groups. The tyre sidewalls are notable for high functionality due to a high 300% modulus, for low hysteresis losses due to a high resilience and for long service life due to an improvement in abrasion resistance.

EP 1 241 219 A1 describes pneumatic tyres comprising a rubber component which consists of rubber gel, syndiotactic 1,2-polybutadiene and a rubber containing double bonds. The rubbers containing double bonds are selected from IR or NR, 3,4-polyisoprene, S-SBR, E-SBR, BR and NBR, the rubbers being used alone or as a blend of two or more rubbers containing double bonds. The rubber component can be used in tyres for cars, motorbikes, aircraft, agricultural vehicles, earthmoving vehicles, offroad vehicles and truck tyres. In EP 1 241 219 A1 there is no pointer to the use of microgel-containing rubber mixtures for winter tyres.

There has to date been no description of tread mixtures which comprise BR gel, silica, solution SBR, high-cis-1,4 BR and natural rubber and/or synthetic polyisoprene, which are suitable for the production of winter tyres and which have high reversion resistance in the course of vulcanization and, within the temperature range of −60° C. to 0° C., good grip on ice and snow, low rolling resistance and high abrasion resistance.

It was therefore an object of the present invention to provide a rubber mixture for the production of winter tyre treads which is reversion-resistant in the course of vulcanization and, in the vulcanized state, within the temperature range of −60° C. to 0° C., has improved grip on snow and ice and high abrasion resistance and low rolling resistance.

A low storage modulus (E′) in the range of −60° C. to −10° C. is an indication of improved grip on ice and snow. Low DIN abrasion is an indication of high abrasion resistance. A low tan δ value at 60° C. indicates low rolling resistance.

It has been found that, surprisingly, this aim is achieved with vulcanizable rubber mixtures comprising at least the following components:

I.) 100 parts by weight of an oil-free rubber matrix consisting of
a) 15 to 79 parts by weight, preferably 20 to 70 parts by weight, of at least one solution SBR (oil-free) having a glass transition temperature (Tg_{(S-SBR)}) between −10° C. and −70° C.,
b) 20 to 75 parts by weight, preferably 25 to 70 parts by weight, of at least one 1,4-cis-polybutadiene (BR) (oil-free) having a glass transition temperature (Tg_{(BR)}) between −100° C. and −115° C.,
c) 1 to 37.5 parts by weight, preferably 5 to 35 parts by weight, of natural rubber (NR) (oil-free) and/or at least one synthetic polyisoprene (IR) having a glass transition temperature (Tg_{(NR)}) between −50° C. and −75 C based on the oil-free natural rubber (NR) or synthetic polyisoprene (IR),

II.) at least one hydroxyl-containing microgel based on polybutadiene,

III.) at least one hydroxyl-containing, oxidic filler,

IV.) at least one polysulphide-containing alkoxysilane,

V.) at least one vulcanizing agent,

VI.) optionally at least one rubber additive.

The sum of the proportions by weight of the rubbers mentioned in Ia), Ib) and Ic) for the rubber matrix adds up to 100 parts by weight (without oil), though the use of oil-extended rubbers too is not ruled out. All other mixture constituents and additives hereinafter are based on 100 parts by weight of the rubber matrix.

The glass transition temperature of the oil-free rubber matrix Tg₍ₘₐₜᵣᵢₓ₎ is calculated by the following general equation:

Tg₍ₘₐₜᵣᵢₓ₎=ΣX_{(KA 1)}×Tg_{(KA 1)}+X_{(KA 2)}×Tg_{(KA 2)}+X_{(KA n)}×Tg_{(KA n)}

where:

X is the proportion by weight of the oil-free rubbers KA1, KA2 and KAn and

Tg is the glass transition temperature of the oil-free rubbers KA1, KA2 and KAn.

In the case of use of the oil-free rubbers Ia), Ib) and Ic), the equation is as follows:

Tg₍ₘₐₜᵣᵢₓ₎=X_{(BR)}×Tg_{(BR)}+X_{(S-SBR)}×Tg_{(S-SBR)}+X_{(NR)}×Tg_{(NR)}

The variables mean:

| | |
|---|---|
| glass transition temperature of the rubber matrix (oil-free) | Tg ₍ₘₐₜᵣᵢₓ₎ |
| proportion by weight of 1,4-cis-polybutadiene (oil-free) | X_{(BR)} |
| proportion by weight of S-SBR (oil-free) | X_{(S-SBR)} |
| proportion by weight of NR or IR (oil-free) | X_{(NR)} |
| glass transition temperature of 1,4-cis-polybutadiene (oil-free) | Tg_{(BR)} |
| glass transition temperature of S-SBR (oil-free) | Tg_{(S-SBR)} |
| glass transition temperature of NR (oil-free) | Tg_{(NR)} |

If more than one rubber of the same type but with different glass transition temperature is used, for example different solution SBR types or different 1,4-cis-polybutadiene types, the calculation of the glass transition temperature of the rubber matrix takes into account the proportions by weight and the glass transition temperatures of each individual rubber component in accordance with the above equation.

The inventive glass transition temperatures of the oil-free rubber matrix are between −70° C. and −90° C.

The glass transition temperatures of the rubbers are determined by means of DSC (Differential Scanning Calorimetry) to DIN EN ISO 11357-1 and DIN EN 61006. The temperature calibration is effected by means of the onset temperatures of the solid/liquid transition (deviations from the starting baseline and the rising melt curve) of indium (156.6° C.) and of lead (328° C.). Prior to commencement of the 1st heating cycle, the sample is cooled with liquid nitrogen to −130° C. at a cooling rate of 320 K/min. The subsequent heating is effected while purging with nitrogen gas at a heating rate of 20 K/min up to a temperature of 150° C. Thereafter, the sample is cooled to −130° C. with liquid nitrogen and heated at 20 K/min. For the evaluation, the thermogram of the 2nd heating step is used. The evaluation is effected by graphic means, by applying three straight lines (see FIG. 1). The glass transition temperature Tg is obtained as the midpoint temperature of the points of intersection Y and Z.

For the determination of the glass transition temperature of oil-extended rubbers, the oil has to be removed from the rubber. The oil can be removed by exhaustive extraction with methanol in a Soxhlet extractor, the determination of the glass transition temperature being preceded by the removal of the adhering acetone under reduced pressure to constant weight. Alternatively, the oil can also be removed by reprecipitation of a toluenic rubber solution with the aid of methanol. For this purpose, the oil-extended rubber is cut into small pieces and dissolved in toluene at room temperature while stirring (1 g of rubber dissolved in 50 g of toluene). Thereafter, the toluenic rubber solution is gradually added dropwise to 500 g of methanol while stirring at room temperature. The coagulated rubber is isolated, the adhering solvent is squeezed off by mechanical means and then the rubber is dried under reduced pressure to constant weight.

Solution SBR Ia) is understood to mean rubbers which are produced in a solution process based on vinylaromatics and dienes, preferably conjugated dienes (H. L. Hsieh, R. P. Quirk, Marcel Dekker Inc. New York-Basle 1996, p. 447-469; Houben-Weyl, Methoden der Organischen Chemie [Methods of Organic Chemistry], Thieme Verlag, Stuttgart, 1987, volume E 20, pages 114 to 134; Ullmann's Encyclopedia of Industrial Chemistry, Vol A 23, Rubber 3. Synthetic, VCH Verlagsgesellschaft mbH, D-69451 Weinheim, 1993, p. 240-364). Suitable vinylaromatic monomers are styrene, o-, m- and p-methylstyrene, technical methylstyrene mixtures, p-tert-butylstyrene, α-methylstyrene, p-methoxystyrene, vinylnaphthalene, divinylbenzene, trivinylbenzene and divinylnaphthalene. Preference is given to styrene. The content of polymerized vinylaromatic is preferably in the range of 5 to 50% by weight, more preferably in the range of 10 to 40% by weight. Suitable diolefins are 1,3-butadiene, isoprene, 1,3-pentadiene, 2,3-dimethylbutadiene, 1-phenyl-1,3-butadiene and 1,3-hexadiene. Preference is given to 1,3-butadiene and isoprene. The content of polymerized dienes is in the range of 50 to 95% by weight, preferably in the range of 60 to 90% by weight. The content of vinyl groups in the polymerized diene is in the range of 10 to 90%, the content of 1,4-trans double bonds is in the range of 10 to 80% and the content of 1,4-cis double bonds is complementary to the sum of vinyl groups and 1,4-trans double bonds. The vinyl content of the S-SBR is preferably >10%.

The polymerized monomers and the different diene configurations are typically distributed randomly in the polymer.

Solution SBR may be either linear or branched, or have end group modification. For example, such types are specified in DE 2 034 989 C2 and JP-A-56-104 906. The branching agent used is preferably silicon tetrachloride or tin tetrachloride.

These vinylaromatic/diene rubbers are produced as rubber component Ia) for the inventive rubber mixtures especially by anionic solution polymerization, i.e. by means of an alkali metal- or alkaline earth metal-based catalyst in an organic solvent.

The solution-polymerized vinylaromatic/diene rubbers have Mooney viscosities (ML 1+4 at 100° C.) in the range of 20 to 150 Mooney units (ME), preferably in the range of 30 to 100 Mooney units. Especially the high molecular weight S-SBR types having Mooney viscosities of >80 ME may contain oils in amounts of 30 to 100 parts by weight based on 100 parts by weight of rubber. Oil-free S-SBR rubbers have glass transition temperatures in the range of −70° C. to −10° C., determined by differential thermoanalysis (DSC).

Solution SBR is especially preferably used in amounts of 25 to 65 parts by weight based on 100 parts by weight of the oil-free rubber matrix.

b) 1,4-cis-Polybutadiene (BR) includes especially polybutadiene types having a 1,4-cis content of at least 90 mol % and is prepared with the aid of Ziegler/Natta catalysts based on transition metals. Preference is given to using catalyst systems based on Ti, Ni, Co and Nd (Houben-Weyl, Methoden der Organischen Chemie, Thieme Verlag, Stuttgart, 1987, volume E 20, pages 798 to 812; Ullmann's Encyclopedia of Industrial Chemistry, Vol A 23, Rubber 3. Synthetic, VCH Verlagsgesellschaft mbH, D-69451 Weinheim, 1993, p. 239-364). The 1,4-cis-polybutadienes (BR) have glass transition temperatures in the range of −95° C. to −115° C., determined by differential thermoanalysis (DSC). The glass transition temperatures for the preferred polybutadiene types (oil-free) are (determined by means of DSC):
Ti-BR: −103° C.
Co-BR: −107° C.
Ni-BR: −107° C.
Nd-BR: −109° C.

The solution-polymerized BR types have Mooney viscosities (ML1+4 at 100° C.) in the range of 20 to 150 Mooney units (ME), preferably in the range of 30 to 100 Mooney units. Especially the high molecular weight BR types having Mooney viscosities of >80 ME may contain oils in amounts of 30 to 100 parts by weight based on 100 parts by weight of rubber. 1,4-cis-Polybutadiene is especially preferably used in amounts of 35 to 65 parts by weight based on 100 parts by weight of the oil-free rubber matrix.

c) Natural Rubber (NR) or Synthetic Polyisoprene (IR):

Polyisoprene (IR) typically has a 1,4-cis content of at least 70 mol %. The term IR includes both synthetic 1,4-cis-polyisoprene and natural rubber (NR).

IR is produced synthetically both by means of lithium catalysts and with the aid of Ziegler/Natta catalysts, preferably with titanium and neodymium catalysts (Houben-Weyl, Methoden der Organischen Chemie, Thieme Verlag, Stuttgart, 1987, volume E 20, pages 114-134; Ullmann's Encyclopedia of Industrial Chemistry, Vol. A 23, Rubber 3. Synthetic, VCH Verlagsgesellschaft mbH, D-69451 Weinheim, 1993, p. 239-364). For the production of synthetic polyisoprene by means of neodymium-based catalyst systems, reference is made especially to WO 02/38635 A1 and WO 02/48218 A1.

The 1,4-cis-polyisoprene used is preferably natural rubber, suitable NR qualities being those such as Ribbed Smoked Sheet (RSS), Air dried sheets (ADS) and pale crepe, and industrial standard qualities such as TSR 5, TSR 10, TSR 20 and TSR 50, irrespective of origin. Prior to use, the natural rubber is masticated.

CV (“constant viscosity”) qualities which are used without prior mastication are also suitable.

Oil-free NR or IR has glass transition temperatures in the range of −50° C. to −75° C., determined by differential thermoanalysis (DSC).

Natural rubber or polyisoprene is especially preferably used in amounts of 10 to 30 parts by weight based on 100 parts by weight of the oil-free rubber matrix.

II.) Hydroxyl-Containing Microgel Based on Polybutadiene

As component II.), at least one hydroxyl-containing microgel based on polybutadiene is used.

Hydroxyl-containing microgels based on polybutadiene in the context of this invention have repeat units of at least one conjugated diene (A), at least one crosslinking monomer (B) and at least one hydroxyl-containing monomer (C).

The conjugated dienes (A) used are preferably 1,3-butadiene, isoprene and 2,3-dimethyl-1,3-butadiene. Preference is given to 1,3-butadiene and isoprene.

Preferably 65 to 94.9% by weight, more preferably 72.5 to 94.0% by weight and especially preferably 80 to 93.5% by weight of the diene (A) is used, based in each case on 100 parts by weight of the monomers used in the polymerization.

The crosslinking monomers (B) used are monomers containing at least 2 double bonds in the molecule. These include the (meth)acrylates of diols having 1 to 20 carbon atoms such as ethanediol di(meth)acrylate, 1,2-propanediol di(meth)acrylate, 1,3-propanediol(meth)acrylate, 1,2-butanediol di(meth)acrylate, 1,3-butanediol di(meth)acrylate, 1,4-butanediol di(meth)acrylate, 1,6-hexanediol di(meth)acrylate (B1), polyethylene glycol di(meth)acrylates and polypropylene glycol di(meth)acrylates, and diols based on copolymers of ethylene oxide and propylene oxide having degrees of polymerization of 1 to 25 (B2), diols based on polymerized tetrahydrofuran having degrees of polymerization of 1 to 25 (B3), the bis- and tris(meth)acrylates of trihydric alcohols, such as trimethylolpropane di(meth)acrylate, trimethylolpropane tri(meth)acrylate, glyceryl di(meth)acrylate and glyceryl tri(meth)acrylate (B4), the bis-, tris- and tetra(meth)acrylates of tetrahydric alcohols, such as pentaerythrityl di(meth)acrylate, pentaerythrityl tri(meth)acrylate and pentaerythrityl tetra(meth)acrylate (B5), aromatic polyvinyl compounds (B6) such as divinylbenzene, diisopropenylbenzene, trivinylbenzene, and other compounds having at least two vinyl groups, such as triallyl cyanurate, triallyl isocyanurate, vinyl crotonate and allyl crotonate (B7). Preference is given to the (meth)acrylic esters of ethanediol, 1,3-propanediol, 1,4-butanediol, 1,6-hexanediol, trimethylolpropane, pentaerythritol and the aromatic polyvinyl compound divinylbenzene.

The crosslinking monomers (B) are used in an amount of 0.1% by weight to 15% by weight, preferably 0.5 to 12.5% by weight, especially preferably 1 to 7.5% by weight, based in each case on 100 parts by weight of the monomers used in the polymerization.

As well as a number of other parameters, such as the amount of regulator typically used in the polymerization, the polymerization conversion and the polymerization temperature, the gel content and the swelling index of the microgels are influenced particularly by the amount of crosslinking monomer (B). In addition, the monomer (B) increases the glass transition temperature of corresponding uncrosslinked homo- and/or copolymers consisting of the monomers (A).

The hydroxyl-containing monomers (C) used are generally hydroxyalkyl(meth)acrylates (C1), hydroxyalkyl crotonates (C2), mono(meth)acrylates of polyols (C3), hydroxyl-modified unsaturated amides (C4), hydroxyl-containing aromatic vinyl compounds (C5) and other hydroxyl-containing monomers (C6).

Hydroxyalkyl(meth)acrylates (C1) are, for example, 2-hydroxyethyl(meth)acrylate, 3-hydroxyethyl(meth)acrylate, 2-hydroxypropyl(meth)acrylate, 3-hydroxypropyl(meth)acrylate, 2-hydroxybutyl(meth)acrylate, 3-hydroxybutyl(meth)acrylate and 4-hydroxybutyl(meth)acrylate.

Hydroxyalkyl crotonates (C2) are, for example, 2-hydroxyethyl crotonate, 3-hydroxyethyl crotonate, 2-hydroxypropyl crotonate, 3-hydroxypropyl crotonate, 2-hydroxybutyl crotonate, 3-hydroxybutyl crotonate and 4-hydroxybutyl crotonate.

Mono(meth)acrylates of polyols (C3) derive from di- and polyhydric alcohols such as ethylene glycol, propanediol, butanediol, hexanediol, trimethylolpropane, glycerol, pentaerythritol, and from oligomerized ethylene glycol and propylene glycol containing 1 to 25 of the glycol units mentioned.

Hydroxyl-modified unsaturated amides (C4) are, for example, monomers such as N-hydroxymethyl(meth)acrylamide, N-(2-hydroxyethyl)(meth)acrylamide and N,N-bis(2-hydroxyethyl)(meth)acrylamide.

Hydroxyl-containing aromatic vinyl compounds (C5) are 2-hydroxystyrene, 3-hydroxystyrene, 4-hydroxystyrene, 2-hydroxy-α-methylstyrene, 3-hydroxy-α-methylstyrene, 4-hydroxy-α-methylstyrene and 4-vinylbenzyl alcohol.

A further hydroxyl-containing monomer (C6) is, for example, (meth)allyl alcohol.

The hydroxyl-containing monomers (C) are used in an amount of preferably 0.1 to 20% by weight, more preferably 0.5 to 15% by weight, especially preferably 1 to 12.5% by weight, based in each case on 100 parts by weight of the monomers used in the polymerization.

The ratio of the polymerized monomers (A), (B) and (C) fixes the glass transition temperature of the microgel. An estimate of the glass transition temperature may proceed from the glass transition temperature of polybutadiene which is prepared by emulsion polymerization. This is approx. −82° C. Components (B) and (C) increase the glass transition temperature according to the amount polymerized, such that the glass transition temperature of the oil-free hydroxyl-containing microgel based on polybutadiene is between −82° C. to −60° C., preferably −65° C. to −82° C., especially preferably −70° C. to −80° C.

The microgel component II.) is used in amounts of 1 to 50 parts by weight, preferably 2.5 to 30 parts by weight, especially preferably 5 to 20 parts by weight of at least one hydroxyl-containing microgel based on 100 parts by weight of oil-free rubber matrix.

The microgel component II.) typically has a gel content of more than 70% by weight, preferably more than 75% by weight, more preferably more than 80% by weight. It additionally has a swelling index (Qi) in toluene of generally less than 30, preferably less than 25, more preferably less than 20, and has a content of polymerized hydroxyl-containing monomers of greater than 0.1% by weight. The hydroxyl number of the resulting microgels is generally greater than 0.5.

Preference is given to hydroxyl-containing microgels based on polybutadiene (II.) and based on the monomers butadiene, trimethylolpropane trimethacrylate and hydroxyethyl methacrylate, and microgels based on butadiene, ethylene glycol dimethacrylate and hydroxypropyl methacrylate.

The hydroxyl-containing microgels are prepared by means of a customary emulsion polymerization of the appropriate monomers, preferably at a temperature of 10 to 100° C., more preferably 12 to 90° C., especially 15 to 50° C. It is possible to conduct the emulsion polymerization in isothermal, semiadiabatic or fully adiabatic mode. The microgel latices obtained in this way also have good shear stability and storage stability. After the polymerization, the microgel latices are processed by spray drying or by coagulation. Appropriately, the latex coagulation is effected within the temperature range of 20 to 100° C.

Suitable polymerization initiators are compounds which decompose to free radicals. These include compounds containing an —O—O— unit (peroxo compounds), an —O—O—H unit (hydroperoxide), and an —N═N— unit (azo compound). Initiation via redox systems is also possible. In addition, it is possible to work with addition of regulator substances known to those skilled in the art. The emulsion polymerization is ended by means of stoppers likewise familiar to those skilled in the art. It has also been found to be useful to conduct the emulsion polymerization using at least one salt of a modified resin acid (I) and at least one salt of a fatty acid (II).

Modified resin acids are compounds which are obtained by dimerization, disproportionation and/or hydrogenation of unmodified resin acids. Suitable unmodified resin acids are, for example, pimaric acid, neoabietic acid, abietic acid, laevopimaric acid and palustric acid. The modified resin acid is preferably a disproportionated resin acid (Ullmann's Encyclopedia of Industrial Chemistry, 6th edition, volume 31, p. 345-355) which is commercially available. The resin acids used are tricyclic diterpenecarboxylic acids obtained from roots, pine balsam and tall oil. These can be converted, for example, to disproportionated resin acids as described in W. Bardendrecht, L. T. Lees in Ullmanns Encyclopidie der Technischen Chemie, 4th edition, vol. 12, 525-538, Verlag Chemie, Weinheim-New York 1976. In addition, at least one salt of a fatty acid is used. These contain preferably 6 to 22 carbon atoms, more preferably 6 to 18 carbon atoms, per molecule. They may be fully saturated or contain one or more double bonds or triple bonds in the molecule. Examples of such fatty acids are caproic acid, lauric acid, myristic acid, palmitic acid, stearic acid, oleic acid, linoleic acid and linolenic acid. The carboxylic acids, in a further configuration of the present invention, may also be in the form of origin-specific mixtures, for example castor oil, cottonseed, peanut oil, linseed oil, coconut fat, palm kernel oil, olive oil, rapeseed oil, soya oil, fish oil and bovine tallow (Ullmann's Encyclopedia of Industrial Chemistry, 6th edition, volume 13, p. 75-108). Preferred carboxylic acids derive from bovine tallow and are partly hydrogenated. Especially preferred, therefore, is partly hydrogenated tallow fatty acid. Both the resin acids and the fatty acids are commercially available as free carboxylic acids, in partly or fully neutralized form.

The resin acids and fatty acids are used as emulsifier in the production of microgels as individual components or together, the amount of resin acid or fatty acid or the sum total of the resin acid and fatty acid being 2.2 to 12.5 parts by weight, preferably 2.5 to 10 parts by weight, especially preferably 2.8 to 7.5 parts by weight, based in each case on 100 parts by weight of the monomer mixture.

The weight ratio of the salts of resin acid (I) and fatty acid (II) is preferably between 0.05:1 and 15:1, more preferably 0.08:1 and 12:1.

For the determination of the alkali addition needed for preparation of the salts in the course of polymerization, the resin acids and fatty acids being used are characterized by acidimetric titration.

In this way, the contents of free carboxylic acids and of emulsifier salts are determined, in order to calculate the for the controlled establishment of the neutralization levels of the resin/fatty acid mixtures used in the polymerization.

For the achievement of good latex stabilities, the neutralization level of the resin/fatty acid mixture is important. The neutralization level of the resin acids (I) and of the fatty acids (II) is preferably 104 to 165%, preferably 106 to 160%, especially preferably 110 to 155%, a neutralization level of 100% being understood to mean complete salt formation and, at a neutralization level of more than 100%, a corresponding excess of base.

For the neutralization of the resin acids and fatty acids, it is possible to use bases, for example LiOH, NaOH, KOH, NH₃ and/or NH₄OH. Preference is given to bases which do not form sparingly soluble salts with the acids. Particularly preferred bases are LiOH, NaOH, KOH and NH₄OH.

For details regarding the production of storage-stable microgel latices, reference is made to P001 00246 (EP 2 186 651).

The hydroxyl-containing microgels have an average particle size of 10 nm to 100 nm.

III.) Hydroxyl-Containing Oxidic Filler

According to the invention, one or more light-coloured reinforcing fillers can be used as component III.). “Light-coloured” in the context of the invention rules out carbon black in particular. The reinforcing light-coloured filler is preferably silica (SiO₂) or alumina (Al₂O₃) or mixtures thereof.

If silica (Ullmann's Encyclopedia of Industrial Chemistry, VCH Verlagsgesellschaft mbH, D-69451 Weinheim, 1993, “Silica”, p. 635-647) is used, it is fumed silica (ibid. p. 635-647) or precipitated silica (ibid. 642-647). Precipitated silicas are obtained by treatment of waterglass with inorganic acids, preference being given to using sulphuric acid. The silicas may optionally also be present as mixed oxides with other metal oxides, such as oxides of Al, Mg, Ca, Ba, Zn, Zr, Ti. Preference is given to precipitated silicas having specific surface areas of 5 to 1000 m²/g, preferably of 20 to 400 m²/g, in each case determined to BET. For the production of tyre treads with low rolling resistance, highly dispersible precipitated silicas are preferred. Examples of preferred highly dispersible silicas include, for example: Perkasil® KS 430 (AKZO). BV 3380 and Ultrasil®7000 (Evonik-Degussa), Zeosil® 1165, MP 1115 MP and HRS 1200 MP (Rhodia), Hi-Sil 2000 (PPG), Zeopol® 8715, 8741 or 8745 (Huber), Vulkasil® S, N and C from Lanxess and treated precipitated silicas, for example aluminium-“doped” silicas described in EP-A-0 735 088. One or more silica types may be used.

Alumina can likewise be used, for example in the form of highly dispersible alumina as described in EP-A-0 810 258. Examples include: A125 or CR125 (Baikowski), APA-1OORDX (Condea), Aluminium oxide C (Degussa) and AKP-GO 15 (Sumitomo Chemicals).

The light-coloured reinforcing filler may be in the form of powders, microbeads, granules or pellets. In a preferred embodiment, silicas and/or aluminas are used. Particular preference is given to silicas, especially precipitated silicas.

The total content of hydroxyl-containing oxidic filler is typically in the range of 10 up to 150 parts by weight, preferably in the range of 20 to 120 parts by weight and especially preferably 25 to 100 parts by weight, based on 100 parts by weight of oil-free rubber matrix.

IV.) Polysulphide-Containing Alkoxysilanes

The polysulphide-containing alkoxysilanes used in accordance with the invention are what are called coupling agents for dispersion and binding of the reinforcing filler into the elastomer matrix. As is known to those skilled in the art, these bear two kinds of functional groups, the alkoxysilyl group which binds to the light-coloured filler, and the sulphur-containing group which binds to the elastomer. According to the invention, one or more of the polysulphide-containing alkoxysilanes can be used in combination.

Particularly suitable polysulphide-containing alkoxysilanes are those of the formulae (1) and (2) which follow, though the definitions which follow should not be understood to be limiting. Those of the formula (1) are those which bear a correspondingly substituted silyl group on both sides of the central sulphur, while this is the case only on one side in the formula (2).

It is thus possible to use polysulphide-containing alkoxysilanes of the general formula (1) or (2)

Z-A-Sₓ-A-Z (1)

Z-A-S_{y}—R³ (2)

in which
x is an integer of 2 to 8,
y is an integer of 1 to 8,
A are the same or different and are each a divalent hydrocarbon group (“spacer”)
Z are the same or different and have one of the following formulae:

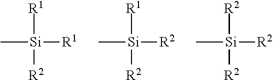

in which
R¹ are the same or different, may be substituted or unsubstituted and are each a C₁-C₁₈ alkyl group, a C₅-C₁₈ cycloalkyl group or C₆-C₁₈ aryl group and
R² are the same or different, may be substituted or unsubstituted and are each a C₁-C₁₈ alkoxy group, a C₅-C₁₈ cycloalkoxy group or C₆-C₁₈ aryloxy group and and
R³ is hydrogen, straight-chain or branched alkyl, where the alkyl chain may optionally be interrupted by one or more, preferably up to five heteroatoms, especially oxygen, sulphur or N(H), aryl, preferably C₆-C₂₀-Aryl and/or a radical having the following structures:

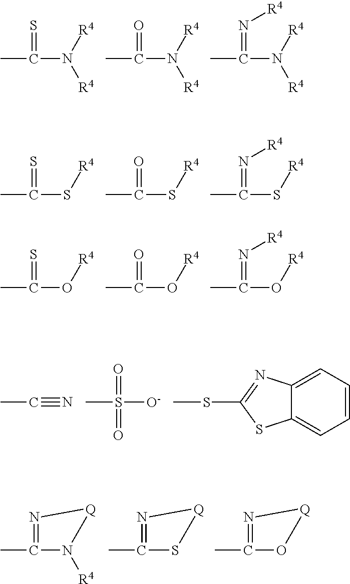

in which R⁴ is an aliphatic, heteroaliphatic, cycloaliphatic, aromatic or heteroaromatic radical having 1 to 20, preferably 1 to 10, carbon atoms and having optionally 1 to 3 heteroatoms, preferably oxygen, nitrogen or sulphur.

In the polysulphide-containing alkoxysilanes of the general formula (1), the number x is preferably an integer from 2 to 5. In the case of a mixture of polysulphide-containing alkoxysilanes of the above-specified formula (1), and especially in the case of customary, commercially available mixtures, “x” is a mean value which is preferably in the range of 2 to 5 and especially close to 2 or 4. The invention can advantageously be conducted with alkoxysilane sulphides where x=2 and x=4.

In the polysulphide-containing alkoxysilanes of the general formulae (1) and (2), the substituted or unsubstituted A groups are the same or different and are preferably each a divalent aliphatic, heteroaliphatic, aromatic or heteroaromatic hydrocarbyl group which is saturated or mono- or polyunsaturated and has 1 to 20, preferably 1 to 18, carbon atoms and optionally 1 to 3 heteroatoms, especially oxygen, sulphur or nitrogen. Suitable A groups are especially C₁-C₁₈ alkylene groups or C₆-C₁₂ arylene groups, more preferably C₁-C₁₀ alkylene groups, especially C₂-C₄ alkylene groups and most preferably propylene.

In the polysulphide-containing alkoxysilanes of the general formulae (1) and (2), R¹ are the same or different and are preferably each C₁-C₆ alkyl, cyclohexyl or phenyl, more preferably C₁-C₄ alkyl and especially methyl and/or ethyl.

In the polysulphide-containing alkoxysilanes of the general formulae (1) and (2), R² are the same or different and are preferably each C₁-C₁₀-alkoxy, more preferably C₁-C₈-alkoxy, especially methoxy and/or ethoxy, C₅-C₈ cycloalkoxy, more preferably cyclohexyloxy, or C₆-C₁₄ aryloxy, more preferably phenoxy.

These “symmetric” polysulphide-containing alkoxysilanes and various processes for preparation thereof are described, for example, in U.S. Pat. No. 5,684,171 and U.S. Pat. No. 5,684,172, which specify a detailed list of known compounds for x in the range of 2 to 8.

The polysulphide-containing alkoxysilane used in accordance with the invention is preferably a polysulphide, especially a disulphide or a tetrasulphide, of bis(C₁-C₄)trialkoxysilylpropyl, more preferably bis(C₁-C₄)trialkoxysilylpropyl and especially bis(2-ethoxysilylpropyl) or bis(3-trimethoxysilylpropyl) or bis(triethoxysilylpropyl). The disulphide of bis(triethoxysilylpropyl) or TESPD of the formula [(C₂H₅O)₃Si(CH₂)₃S]₂ is commercially available, for example, from Evonik Degussa under the Si266 or Si75 names (in the second case in the form of a mixture of disulphide and polysulphide), or else from Witco under the Silquest A 1589 name. The tetrasulphide of bis(triethoxysilylpropyl) or TESPT of the formula [(C₂H₅O)₃Si(CH₂)₃S₂]₂ is available, for example, from Evonik Degussa under the SI 69 name (or X-50S with 50% by weight of carbon black as a carrier) or from Witco under the Silquest A 1289 name (in both cases, a commercial mixture of polysulphide having a mean value for x close to 4).

The polysulphide-containing alkoxysilanes are used in the inventive rubber mixtures appropriately at 0.2 to 12 parts by weight, preferably 1 to 10 parts by weight, based on 100 parts by weight of oil-free rubber matrix.

V.) Vulcanizing Agent

According to the invention, one or more vulcanizing agents and/or vulcanization aids can be used. Some examples are given below.

Sulphur and Sulphur Donors

For crosslinking of the inventive rubber mixtures, sulphur is suitable, either in the form of elemental sulphur or in the form of a sulphur donor. Elemental sulphur is used in the form of soluble or insoluble sulphur.

Soluble sulphur is understood to mean the only form which is stable at normal temperatures, yellow cyclooctasulphur (S₈) or α-S, which consists of typical rhombic crystals and has high solubility in carbon disulphide. For instance, at 25° C., 30 g of α-S dissolve in 100 g of CS₂ (see “Schwefel” [Sulphur] in the online Römpp Chemie Lexikon, August 2004 version, Georg Thieme Verlag Stuttgart).

Insoluble sulphur is understood to mean a sulphur polymorph which does not have a tendency to exude at the surface of rubber mixtures. This specific sulphur polymorph is insoluble to an extent of 60 to 95% in carbon disulphide.

Examples of sulphur donors are caprolactam disulphide (CLD), dithiomorpholine (DTDM) or 2-(4-morpholinodithio)benzothiazole (MBSS) (W. Hoffmann “Kautschuktechnologie” [Rubber Technology], p. 254 if, Gentner Verlag Stuttgart (1980)).

Sulphur and/or sulphur donors are used in the inventive rubber mixture in an amount in the range of 0.1 to 15 parts by weight, preferably 0.1-10 parts by weight, based on 100 parts by weight of oil-free rubber matrix.

Vulcanization Accelerators

In the inventive rubber mixture, it is additionally also possible to use one or more vulcanization accelerators suitable for sulphur vulcanization.

Corresponding vulcanization accelerators are mentioned in J. Schnetger “Lexikon der Kautschuktechnik” [Lexicon of Rubber Technology], 3rd edition, Hüthig Verlag Heidelberg, 2004, pages 514-515, 537-539 and 586-589.

In the context of the present invention, such vulcanization accelerators may, for example, be selected from the group of the xanthogenates, dithiocarbamates, tetramethylthiuram disulphides, thiurams, thiazoles, thiourea derivatives, amine derivatives such as tetramines, sulphenimides, piperazines, amine carbamates, sulphenamides, bisphenol derivatives and triazine derivatives, and also polythiophosphorus compounds of the general formula (3) or (4)

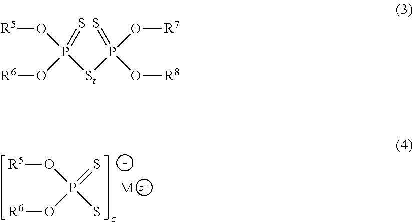

in which
R⁵, R⁶, R⁷ and R⁸ are the same or different and are each aliphatic, heteroaliphatic, aromatic or heteroaromatic radicals having 1 to 24, preferably 1 to 18, carbon atoms, and optionally 1 to 4 heteroatoms, especially N, S or O,
t is an integer of 1 to 8, preferably 3 to 6,
z is an integer of 1 to 3, preferably 1 to 2, and
M^{z+} is a metal cation with the charge z+, where z+ is 1 to 3, preferably 1 and 2, or a cation of the formula N(R⁹)₄⁺ in which R⁹ are the same or different and are each hydrogen and/or as defined for R⁵.

The compounds of the general formula (3) are phosphoryl polysulphides, and the compounds of the general formula (4) dithiophosphates.

The following metal cations are options for M: Li, Na, K, Rb, Cs, Be, Mg, Ca, Sr, Ba, Al, Nd, Zn, Cd, Ni and Cu. Preference is given to: Na, K, Zn and Cu. Likewise preferably, M^{z+} is NH₄⁺.

The following metal dithiophosphates are of particular interest:

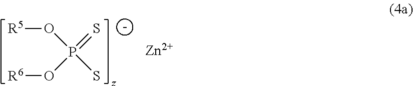

in which
z is 2
R⁵ and R⁶ are the same or different and are each hydrogen or a straight-chain or branched, substituted or unsubstituted alkyl group or cycloalkyl group having 1 to 12 carbon atoms, more preferably a C₂-C₁₂ alkyl group or a C₅-C₁₂ cycloalkyl group and especially ethyl, propyl, isopropyl, butyl, isobutyl, cyclohexyl, ethylhexyl or dodecyl.

Such compounds of the general formula (3) or (4) may optionally also be used in supported or polymer-bound form.

Suitable vulcanization accelerators are benzothiazyl-2-cyclohexylsulphenamide (CBS), benzothiazyl-2-tert-butylsulphenamide (TBBS), benzothiazyl-2-dicyclohexylsulphenamide (DCBS), 1,3-diethylthiourea (DETU), 2-mercaptobenzothiazole (MBT) and zinc salts thereof (ZMBT), copper dimethyldithiocarbamate (CDMC), benzothiazyl-2-sulphene morpholide (MBS), benzothiazyldicyclohexylsulphenamide (DCBS), 2-mercaptobenzothiazole disulphide (MBTS), dimethyldiphenylthiuram disulphide (MPTD), tetrabenzylthiuram disulphide (TBZTD), tetramethylthiuram monosulphide (TMTM), dipentamethylenethiuram tetrasulphide (DPTT), tetraisobutylthiuram disulphide (IBTD), tetraethylthiuram disulphide (TETD), tetramethylthiuram disulphide (TMTD), zinc N-dimethyldithiocarbamate (ZDMC), zinc N-dicthyldithiocarbamate (ZDEC), zinc N-dibutyldithiocarbamate (ZDBC), zinc N-ethylphenyldithiocarbamate (ZEBC), zinc dibenzyldithiocarbamate (ZBEC), zinc diisobutyldithiocarbamate (ZDiBC), zinc N-pentamethylendithiocarbamate (ZPMC), zinc N-ethylphenyldithiocarbamate (ZEPC), zinc 2-mercaptobenzothiazole (ZMBT), ethylenethiourea (ETU), tellurium diethyldithiocarbamate (TDEC), diethylthiourea (DETU), N,N-ethylenethiourea (ETU), diphenylthiourea (DPTU), triethyltrimethyltriamine (TTT); N-t-butyl-2-benzothiazolesulphenimide (TBSI); 1,1′-dithiobis(4-methylpiperazine); hexamethylenediamine carbamate (HMDAC); benzothiazyl-2-tert-butylsulphenamide (TOBS), N,N′-diethylthiocarbamyl-N′-cyclohexylsulphenamide (DETCS), N-oxydiethylenedithiocarbamyl-N′-oxydiethylenesulphenamide (OTOS), 4,4′-dihydroxydiphenyl sulphone (Bisphenol S), zinc isopropylxanthogenate (ZIX), selenium salts, tellurium salts, lead salts, copper salts and alkaline earth metal salts of dithiocarbamic acids; pentamethyleneammonium N-pentamethylenedithiocarbamate; cyclohexylethylamine; dibutylamine; polyethylenepolyamines, polyethylenepolyimines, for example triethylenetetramine (TETA), phosphoryl polysulphides, for example:

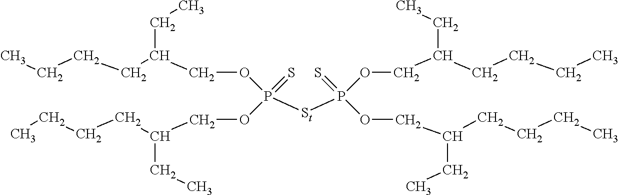

where t=2 to 4, (Rhenocure® SDT/S bound to 30% by weight of high-activity silica from Rhein Chemie Rheinau GmbH) and zinc dithiophosphate, for example Rhenocure ZDT/G bound to 30% by weight of high-activity silica and 20% by weight of polymer binder from Rhein Chemie Rheinau GmbH having the formula

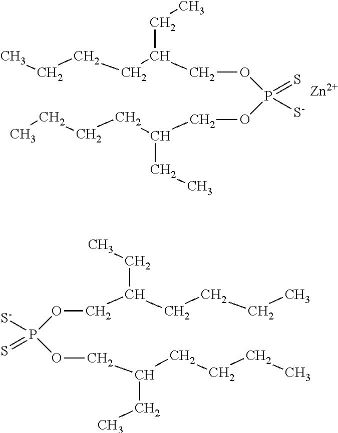 [SMILES: CCCCC(CC)COP(=S)([S-])OCC(CC)CCCC ; [Zn+2] ; CCCCC(CC)COP(=S)([S-])OCC(CC)CCCC]

The vulcanization accelerators are preferably used in an amount in the range of 0.1 to 15 parts by weight, preferably 0.1-10 parts by weight, based on 100 parts by weight of oil-free rubber matrix.

Zinc Oxide and Stearic Acid or Zinc Stearate

The inventive mixture may further comprise zinc oxide as an activator for the sulphur vulcanization. The selection of a suitable amount is possible for the person skilled in the art without any great difficulty. If the zinc oxide is used in a somewhat higher dosage, this leads to increased formation of monosulphidic bonds and hence to an improvement in ageing resistance. The inventive rubber composition further comprises stearic acid (octadecanoic acid). This is known by the person skilled in the art to have a broad spectrum of action in rubber technology. For instance, one of its effects is that it leads to improved dispersion of zinc oxide and of the vulcanization accelerator. In addition, complex formation occurs with zinc ions in the course of sulphur vulcanization.

Zinc oxide is used in the inventive composition typically in an amount of 0.5 to 15 parts by weight, preferably 1 to 7.5 parts by weight, especially preferably 1 to 5% by weight, based on 100 parts by weight of oil-free rubber matrix.

Stearic acid is used in the inventive composition in an amount of 0.1 to 7, preferably 0.25 to 7, parts by weight, preferably 0.5 to 5 parts by weight, based on 100 parts by weight of oil-free rubber matrix.

Alternatively or else additionally to the combination of zinc oxide and stearic acid, zinc stearate may be used. In this case, typically an amount of 0.25 to 5 parts by weight, preferably 1 to 3 parts by weight, based in each case on 100 parts by weight of the oil-free rubber matrix, is used.

VI.) Optionally One or More Rubber Additives

Further rubber additives to be added optionally as component(s) VI.) of the inventive rubber mixtures include ageing stabilizers, reversion stabilizers, light stabilizers, ozone stabilizers, waxes, mineral oil, processing aids, plasticizers, tackifiers, blowing agents, dyes, pigments, resins, extenders, organic acids, vulcanization accelerators, metal oxides and further filler-activators, for example triethanolamine, trimethylolpropane, polyethylene glycol, hexanetriol or other additives, for instance carbon black, known in the rubber industry (Ullmann's Encyclopedia of Industrial Chemistry, VCH Verlagsgesellschaft mbH, D-69451 Weinheim, 1993, vol A 23 “Chemicals and Additives”, p. 366-417).

The vulcanization accelerators added to the inventive compositions may, for example, be sulphonamides, sulphanilides or phthalimides. Suitable examples are N-cyclohexylthiophthalimide, phthalic anhydride (PTA), salicylic acid (SAL), N-nitrosodiphenylamine (NDPA), trichloromelamine (TCM), maleic anhydride (MSA) and N-trichloromethylsulphenylbenzenesulphanilide (the latter being commercially available under the Vulkalent® E name). Corresponding vulcanization accelerators are likewise mentioned in J. Schnetger, “Lexikon der Kautschuktechnik”, 3rd edition, Hilthig Verlag, Heidelberg, 2004, page 590.

The antioxidants added to the inventive compositions may, for example, be mercaptobenzimidazole (MBI), 2-mercaptomethylbenzimidazole (2-MMBI), 3-mercaptomethylbenzimidazole (3-MMBI), 4-mercaptomethylbenzimidazole (4-MMBI), 2,2,4-trimethyl-1,2-dihydroquinoline (TMQ), nickel dibutyldithiocarbamate (NDBC), 2,6-di-tert-butyl-p-cresol (BHT) and 2,2′-methylenebis(4-methyl-6-tert-butylphenol) (BKF). These antioxidants may also be used in non-dusting, especially also polymer-bound, supply forms (as “microgranules” (MG) or “microgranules coated” (MGC)).

In addition, it is also possible to use ageing stabilizers, for example in the form of discolouring ageing stabilizers with antifatigue and antiozone action, for example N-isopropyl-N′-phenyl-p-phenylenediamine (IPPD); N-1,3-dimethylbutyl-N′-phenyl-p-phenylenediamine (6PPD), N-1,4-dimethylpentyl-N′-phenyl-p-phenylenediamine (7PPD), N,N′-bis-(1,4-dimethylpentyl)-p-phenylenediamine (77PD) etc., discolouring ageing stabilizers with fatigue protection but no antiozone action, for example phenyl-α-naphthylamine (PAN); discolouring ageing stabilizers with low antifatigue action and no antiozone action, for example octylated diphenylamine (ODPA); non-discolouring ageing stabilizers with fatigue protection and good heat protection, for example styrenized phenols (SPH); non-discolouring ozone stabilizers with no anti-ageing action, for example waxes (mixtures of specific hydrocarbons), cyclic acetals and enol ethers; and hydrolysis stabilizers, for example polycarbodiimides.

In addition, mastication chemicals can also be added to the inventive rubber mixtures, these preferably being selected from the group consisting of thiophenols, thiophenol zinc salts, substituted aromatic disulphides, derivatives of thiocarboxylic acids, hydrazine derivatives, nitroso compounds and metal complexes, especially preferably iron hemiporphyrazine, iron phthalocyanine, iron acetonylacetate and the zinc salt thereof. The mastication chemicals are especially used for mastication of the natural rubber used in the mixture, the mastication of the natural rubber preferably being conducted in a separate process step prior to the actual mixture production.

It is nonetheless possible in accordance with the invention, in addition to the light-coloured filler, to use a certain amount of carbon black, especially carbon blacks of the HAF, ISAF and SAF type which are used customarily in pneumatic tyres and especially in the treads of pneumatic tyres. Examples of these carbon blacks include N110, N 115, N220, N134, N234, N339, N347 and N375, which are sufficiently well known to those skilled in the art and are commercially available from various manufacturers.

If carbon black is added, the proportion of the light-coloured reinforcing filler is, however, more than 50% by weight, preferably more than 75% by weight, based on the total amount of the reinforcing fillers used. The proportion of carbon black is then less than 50% by weight and more preferably less than 40% by weight. In a preferred embodiment, in the inventive rubber mixture, carbon black is added in amounts of 0 to 35 parts by weight based on 100 parts by weight of the sum of the oil-free rubbers.

The rubber additives usable as component(s) VI.) are used in customary amounts guided by factors including the end use. Customary amounts for individual rubber additives are, for example, 0.1 to 50 phr, this stated amount neglecting oil which is introduced into the rubber mixtures as an extender of rubbers.

Preferably, another version of the invention has a vulcanizable rubber mixture free of polythiophosphorus compounds.

The invention provides the rubber mixtures mentioned, and also vulcanizates obtained therefrom by sulphur crosslinking, especially various components of pneumatic tyres, especially of tyre treads, and in particular treads of winter tyres produced therefrom.

The inventive rubber mixtures are illustrated hereinafter by examples.

Production of the Rubber Mixtures

The inventive rubber mixture is produced by mixing components I.) to VI.) The mixing can be effected in one stage or up to 6 stages. A three-stage mixing operation with two mixing stages in an internal mixer and a final mixing stage on a roller (called “ready-mixing stage”) has been found to be useful. Another possibility is a two-stage mixing operation with the 1st mixing stage in an internal mixer and the 2nd mixing stage on a roller. A further possibility is a 2-stage mixing operation in which both mixing stages are effected in an internal mixer, the mixture being cooled prior to addition of the components which are typically added on the roller to temperatures of <120° C., preferably <110° C.

It has been found to be useful to add component I.) in the form of the light-coloured filler completely in the 1st mixing step, and component II.) in the form of the hydroxyl-containing microgel completely in the first mixing step or else divided between the first and second mixing steps or else in the second or a later mixing step. The polysulphide-containing alkoxysilane (IV.) can likewise be added either completely in the first mixing step or else divided between the first and later mixing steps.

Suitable equipment for the mixture production is known per se and includes, for example, rollers, internal mixers or else mixing extruders.

In the case of use of a 2-stage mixing operation in an internal mixer or a three- or multistage mixing process, in the first and/or in the second and later mixing stages, preferably in the first and second mixing stages, temperatures of 110° C. to 180° C., preferably 120° C. to 175° C., especially preferably 125° C. to 170° C., are employed, the mixing times at these temperatures being in the range of 1 to 15 minutes and being selected such that vulcanization does not begin at this early stage (incipient vulcanization or scorch).

The temperatures in the ready-mixing stage are 20 to 120° C., preferably 30 to 110° C.

Typically, the mixing in an internal mixer is effected within a temperature range of 20 to 180° C., preferably within the temperature range of 50 to 170° C., or on a roller at less than 100° C. The selection of a suitable temperature can be undertaken by the person skilled in the art on the basis of his or her specialist knowledge, ensuring that, on the one hand, the silica is silanized in the course of mixing and, on the other hand, there is no premature vulcanization (scorching).

Process for Producing Vulcanizates:

The vulcanization of the inventive compositions is effected typically at a temperature in the range of 100 to 250° C., preferably of 130 to 180° C., either under standard pressure (1 bar) or optionally under a pressure of up to 200 bar.

The compositions produced in accordance with the invention are suitable for production of pneumatic tyres, especially of tyre treads, and in particular for production of treads for winter tyres.

### EXAMPLES

Table K summarizes the rubbers Ia), Ib) and Ic) (solution SBR, 1,4-cis-polybutadiene, natural rubber) used in the examples which follow for the rubber matrix, and important properties of these rubbers.

TABLE K
Rubbers used (solution SBR, 1,4-cis-polybutadiene, natural rubber) and their properties

| | | | | Styrene | Oil-extended rubber | | | |
|---|---|---|---|---|---|---|---|---|
| | | Mooney viscosity | Vinyl | content | | Oil | | Tg of the oil- |
| | Mixture | ML 1 + 4 (100° C.) | content | [% by | Oil | content | Tg | free rubber |
| Rubber | constituent | [ME] | [mol %] | wt.] | type | [phr] | [° C.] | [° C.] |
| Buna ® VSL 5025-1 HM | Ia) | 65 | 50 | 25 | DAB | 37.5 | −24 | −21 |
| (solution SBR from Lanxess | | | | | | | | |
| Deutschland GmbH) | | | | | | | | |
| Buna ® VSL 5025-2 HM | Ia) | 62 | 50 | 25 | TDAE | 37.5 | −29 | −22 |
| (solution SBR from Lanxess | | | | | | | | |
| Deutschland GmbH) | | | | | | | | |
| Buna ® VSL 5228-2 (solution | Ia) | 50 | 52 | 28 | TDAE | 37.5 | −20 | −13 |
| SBR from Lanxess Deutschland | | | | | | | | |
| GmbH) | | | | | | | | |
| Buna ® VSL 5025-0 HM | Ia) | 65 | 50 | 25 | — | — | — | −22 |
| (solution SBR from Lanxess | | | | | | | | |
| Deutschland GmbH) | | | | | | | | |
| Buna ® VSL 2525-0 M (solution | Ia) | 54 | 25 | 25 | — | — | — | −49 |
| SBR from Lanxess Deutschland | | | | | | | | |
| GmbH) | | | | | | | | |
| Buna ® CB 24 (neodymium BR | Ib) | 43.4 | 0.6 | — | — | — | — | −109 |
| from Lanxess Deutschland | | | | | | | | |
| GmbH) | | | | | | | | |
| Buna ® CB 1203 (cobalt BR from | Ib) | 43 | 2.0 | — | — | — | — | −107 |
| Lanxess Deutschland GmbH) | | | | | | | | |
| Natural rubber (RSS 3, | Ic) | — | — | — | — | — | — | −66 |
| premasticated to DEFO hardness | | | | | | | | |
| 1000) | | | | | | | | |

For the determination of the glass transition temperatures (Tg), the DSC-7 calorimeter from Perkin-Elmer was used. In each case 10 mg of the rubber were weighed into the standard aluminium crucible supplied by the manufacturer and encapsulated. For the evaluation, the thermogram of the 2nd heating step is used.

The glass transition temperatures of the oil-extended rubbers (Buna® VSL 5025-1 HM, Buna® VSL 5025-2 HM and Buna® VSL 5228-2) were determined both in the original state, i.e. with oil, and after removal of the oil. For removal of the oil, the oil-extended rubbers were reprecipitated. For this purpose, the oil-extended rubber was cut into small pieces and dissolved in toluene at room temperature while stirring (1 g of rubber dissolved in 50 g of toluene). After the rubber had completely dissolved, the toluenic rubber solution was gradually added dropwise to 500 g of methanol while stirring at room temperature. The coagulated rubber was isolated, the adhering solvent was squeezed off and then the rubber was dried under reduced pressure to constant weight. As can be seen in Table K, the glass transition temperatures of the oil-extended rubbers differ in the original state and after oil removal. To calculate the glass transition temperatures of the rubber matrix, in all cases, the glass transition temperatures of the rubbers was used after oil removal by reprecipitation.

Rubber Gels

For the present invention, a BR gel having a Tg=−75° C. was used. This gel has an insoluble fraction of 95% by weight in toluene. The swelling index in toluene is: 11.5. The hydroxyl number of the gel is 30 mg KOH/g of gel.

The BR gel is produced by copolymerization of a monomer mixture whose composition is listed in Table M below, employing the polymerization conditions disclosed in EP 1 298 166 under the heading “[1] Production of Rubber Gel” in paragraph [0077].

TABLE M
Monomer mixture

| | Proportions |
|---|---|
| Monomers | [parts by wt.] |
| Butadiene | 88.5 |
| Trimethylolpropane trimethacrylate | 4.0 |
| Hydroxyethyl methacrylate | 7.5 |

The further treatment and workup of the BR gel latex obtained in the polymerization were as described in EP 1245 630 “Production Example 1: Production of Conjugated Diene-Based Rubber Gel 1” in paragraphs [0103] and [0104].

TABLE MC
Mixture constituents III.) to IV.)

| Mixture constituents | | Product name (manufacturer) |
|---|---|---|
| III.) | silica | Ultrasil ® VN3 (Evonik GmbH) |
| III.) | silica | Ultrasil ® 7000 GR (Evonik GmbH) |
| VI.) | carbon black | Statex ® N330 (Columbian Carbon Deutschland) |
| VI.) | ageing | 2,2,4-trimethy1-1,2-dihydroquinoline, polymerized |
| | stabilizer | (Vulkanox ® HS/LG from Lanxess Deutschland |
| | | GmbH) |
| VI.) | ageing | N-1,3-dimethylbutyl-N′-phenyl-p-phenylenediamine |
| | stabilizer | (Vulkanox ® 4020/LG (Lanxess Deutschland GmbH) |
| VI.) | ozone wax | Antilux ® 654 (RheinChemie GmbH) |
| V.) | stearic acid | Edenor ® C 18 98-100 (Cognis Deutschland GmbH) |
| VI.) | mineral oil | Vivatech ®500 (Hansen und Rosenthal) |
| IV.) | polysulphide- | bis(triethoxysilylpropylmonosulphane) |
| | containing | (Si 75/Degussa Hüls AG) |
| | alkoxysilane | |
| IV.) | polysulphide- | bis(triethoxysilylpropyldisulphane) |
| | containing | (Si 69/Degussa Hills AG) |
| | alkoxysilane | |
| V.) | zinc oxide | red seal zinc white (Grillo Zinkoxid GmbH) |
| V.) | sulphur | soluble sulphur (Chancel ® 90/95° ground sulphur |
| | | (Solvay Barium Strontium) |
| V.) | vulcanization | N-tert-butyl-2-benzthiazylsulphenamide, Vulkacit ® |
| | accelerator | NZ/C (Lanxess Deutschland GmbH) |
| V.) | vulcanization | diphenylguanidine, Rhenogran ® DPG-80 |
| | accelerator | (RheinChemie GmbH) |

Production of the Rubber Mixtures of Mixture Series 1) to 6)

The rubber mixtures were produced in a 3-stage mixing process, in each case using an internal mixture of capacity 1.5 l (GK 1,5 from Werner & Pfleiderer, Stuttgart) with intermeshing kneading elements (PS 5A paddle geometry) for the 1st and 2nd mixing stages. The 3rd mixing stage was conducted on a thermostatable roller at a maximum roller temperature of 60° C.

The mixture constituents used were each based on 100 parts by weight of oil-free rubber matrix. The addition sequence of the mixture constituents and the times of addition are shown in the tables corresponding to the individual mixing series.

In the 1st mixing step, the mixture constituents listed in the tables were introduced into the internal mixer heated to 70° C. and mixed at a fill level of 72%, at a ram pressure of 8 bar and a kneader speed of 70 min⁻¹. For silanization, the mixtures were heated to the temperatures specified in the mixture series by increasing the speed and kept at these temperatures for the times stated in the tables. Thereafter, the mixtures were ejected and cooled to <90° C. on a roller.

After storage at 23° C. for 24 hours, the mixtures were redispersed in a 2nd mixing stage in the internal mixer, optionally after addition of further components (see mixture series) (fill level: 72%, ram pressure: 8 bar, rotational speed: 70 min.-1) and heated to the temperatures specified in the mixture series by increasing the rotational speed and then kept at these temperatures for the times stated in the mixture series. Thereafter, the mixture was ejected and cooled to <60° C. on a roller preheated to 40° C.

The mixture constituents specified in the tables below were added in a 3rd mixing stage on the roller at maximum temperatures of 60° C. without preceding intermediate storage.

Tests

Using the unvulcanized rubber mixtures, the Mooney viscosity after 1 min. (ML1+1/100° C.) and after 4 min. (ML1+4/100° C.) and the Mooney relaxation after 10 and 30 sec were determined to ASTM D1646:

The vulcanization characteristics of the mixtures were studied in a rheometer at 160° C. to DIN 53 529 with the aid of the MDR 2000E Monsanto rheometer. In this way, characteristic data such as F_{min.}, Fₘₐₓ, F_{max.}-F_{min.}, t₁₀, t₅₀, t₉₀ and t₉₅, and also F_{15 min}, F_{20 min.} F_{25 min.} and F_{25 min}-Fₘₐₓ, were determined.

Definitions according to DIN 53 529, Part 3 are:

Fₘᵢₙ: vulcameter reading at the minimum of the crosslinking isotherm

Fₘₐₓ: vulcameter reading at the maximum of the crosslinking isotherm

Fₘₐₓ-Fₘᵢₙ: difference in the vulcameter readings between maximum and minimum

t₁₀: time at which 10% of the conversion has been attained

t₅₀ time at which 50% of the conversion has been attained

t₉₀: time at which 90% of the conversion has been attained

t₉₅: time at which 95% of the conversion has been attained

The reversion characteristics were characterized by the following parameters:

F_{15 min},: vulcameter reading after 15 min.

F_{20 min}, vulcameter reading after 20 min.

F_{25 min}, vulcameter reading after 25 min.

F_{25 min}-Fₘₐₓ difference between the vulcameter reading after 25 min. and the maximum value

A rubber mixture with good reversion characteristics features a substantially constant vulcameter reading in the course of long vulcanization times; i.e. the change relative to the vulcameter maximum should be at a minimum. What is absolutely undesirable is a decrease in the vulcameter reading with increasing vulcanization times (“reversion”). This is an indication of poor ageing characteristics of the vulcanizate, with a decrease in the degree of crosslinking or in the modulus during the use time. Equally undesirable is a rise in the vulcameter reading after attainment of the maximum (“marching modulus”). A measure employed for the reversion resistance of the rubber mixtures was the difference in the vulcameter readings between 25 min and the maximum (F_{25 min}-Fₘₐₓ). In the case of the inventive mixtures, this value is <−0.47 dNm.

The specimens needed for the vulcanizate characterization were produced by press vulcanization of the mixtures at a hydraulic pressure of 120 bar. The vulcanization conditions used for the production of the specimens are stated for the individual test series.

Using the vulcanizates, the following properties were determined to the standards specified:
DIN 53505: Shore A hardness at 23° C. and 70° C.
DIN 53512: Resilience at 23° C. and 70° C. (“R23”)
DIN 53504: Stress values at 10%, 25%, 50%, 100%, 200% and 300% strain (σ₁₀, σ₂₅, σ₅₀, σ₁₀₀, σ₂₀₀ and σ₃₀₀), tensile strength and elongation at break
DIN 53516: Abrasion

For the determination of the dynamic properties (temperature dependence of the storage modulus E′ in the temperature range of −60° C. to 0° C. and tan δ at 60° C.), an Eplexor instrument (Eplexor 500 N) from Gabo-Testanlagen GmbH, Ahlden, Germany was used. The measurements were determined to DIN53513 at 10 Hz on cylinder samples within the temperature range of −100° C. to +100° C. at a heating rate of 1 K/min. The measurements were effected in compression mode at a static compression of 1% and a dynamic deformation of 0.1%.

The method was used to obtain the following parameters which are named according to ASTM 5992-96:
E′ (−60° C.): storage modulus at −60° C.
E′ (−50° C.): storage modulus at −50° C.
E′ (−40° C.): storage modulus at −40° C.
E′ (−30° C.): storage modulus at −30° C.
E′ (−20° C.): storage modulus at −20° C.
E′ (−10° C.): storage modulus at −10° C.
E′ (0° C.): storage modulus at 0° C.
   and
tan δ (60° C.): loss factor (E″/E′) at 60° C. E′ gives an indication of the grip of the winter tyre tread on ice and snow. The lower the E′, the better the grip.

Tan δ (60° C.) is a measure of the hysteresis loss in the rolling of the tyre. The lower the tan δ (60° C.), the lower the rolling resistance of the tyre.

Summary of the Results

6 mixture series were produced, varying both the mixing ratios of solution SBR, 1,4-cis-polybutadiene and NR and the proportions of microgel. The inventive examples are each identified by “*”.

1st Mixture Series

In mixing series 1), variation in the ratio of solution SBR, cis-1,4-polybutadiene and natural rubber resulted in variation of the glass transition temperatures of the rubber matrix between −58.4° C. and 84.1° C. (see Table 1.1 below). On the basis of the matrix Tg of −73.0 to −84.1° C. and the NR content of 10 to 30 parts by weight, 1.2*, 1.3*, 1.4* and 1.7* are inventive examples. Examples 1.5 and 1.6 are noninventive, since the NR content at 45 or 80 parts by weight is outside the inventive range.

TABLE 1.1
Glass transition temperature of the rubber matrix

| Compound No. | 1.1 | 1.2* | 1.3* | 1.4* | 1.5 | 1.6 | 1.7* |
|---|---|---|---|---|---|---|---|
| Buna ® VSE 2525-0 M | 70 | 50 | 44 | 25 | 30 | 10 | 20 |
| Buna ® CB 24 | 10 | 40 | 36 | 30 | 25 | 10 | 50 |
| TSR/RSS 3 DEFO 1000 | 20 | 10 | 20 | 35 | 45 | 80 | 30 |
| Matrix Tg | −58.4 | −74.7 | −74.0 | −73.0 | −71.7 | −68.6 | −84.1 |

TABLE 1.2
1st mixing stage in the internal mixer

| | | | | | | | |
|---|---|---|---|---|---|---|---|
| Compound No. | 1.1 | 1.2* | 1.3* | 1.4* | 1.5 | 1.6 | 1.7* |

Time of addition: 0 sec.

| | | | | | | | |
|---|---|---|---|---|---|---|---|
| Buna ® VSL 2525-0 HM | 70 | 50 | 44 | 25 | 30 | 10 | 20 |
| Buna ® CB 24 | 10 | 40 | 36 | 30 | 25 | 10 | 50 |
| TSR/RSS 3 DEFO 1000 | 20 | 10 | 20 | 35 | 45 | 80 | 30 |

Time of addition: 30 sec.

| | | | | | | | |
|---|---|---|---|---|---|---|---|
| Ultrasil ® VN3 | 53 | 53 | 53 | 53 | 53 | 53 | 53 |
| BR microgel | 10 | 10 | 10 | 10 | 10 | 10 | 10 |
| Vulkanox ® HS/LG | 1.0 | 1.0 | 1.0 | 1.0 | 1.0 | 1.0 | 1.0 |
| Vulkanox ® 4020/LG | 1.0 | 1.0 | 1.0 | 1.0 | 1.0 | 1.0 | 1.0 |
| stearic acid | 1.0 | 1.0 | 1.0 | 1.0 | 1.0 | 1.0 | 1.0 |
| ozone wax | 1.4 | 1.4 | 1.4 | 1.4 | 1.4 | 1.4 | 1.4 |

TABLE 1.2
1st mixing stage in the internal mixer

| | | | | | | | |
|---|---|---|---|---|---|---|---|
| Si75 | 3.2 | 3.2 | 3.2 | 3.2 | 3.2 | 3.2 | 3.2 |

Time of addition: 90 sec.

| | | | | | | | |
|---|---|---|---|---|---|---|---|
| Ultrasil ® VN3 | 27 | 27 | 27 | 27 | 27 | 27 | 27 |
| mineral oil | 20 | 20 | 20 | 20 | 20 | 20 | 20 |
| carbon black | 12 | 12 | 12 | 12 | 12 | 12 | 12 |

Time of addition: 150 sec.

| | | | | | | | |
|---|---|---|---|---|---|---|---|
| zinc oxide | 2.5 | 2.5 | 2.5 | 2.5 | 25 | 2.5 | 2.5 |

Heating from 210 sec.

| | | | | | | | |
|---|---|---|---|---|---|---|---|
| Maximum temperature | 165 | 165 | 165 | 165 | 165 | 165 | 165 |
| [° C.] | | | | | | | |
| Time at max. temperature | 6 | 6 | 6 | 6 | 6 | 6 | 6 |
| [min] | | | | | | | |
| Cooling on roller [° C.] | <90 | <90 | <90 | <90 | <90 | <90 | <90 |
| Storage at 23° C. [h] | 24 | 24 | 24 | 24 | 24 | 24 | 24 |

TABLE 1.3
2nd mixing stage in the internal mixer

| Compound No. | 1.1 | 1.2* | 1.3* | 1.4* | 1.5 | 1.6 | 1.7* |
|---|---|---|---|---|---|---|---|
| Si75 | 3.2 | 3.2 | 3.2 | 3.2 | 3.2 | 3.2 | 3.2 |
| Maximum temperature | 165 | 165 | 165 | 165 | 165 | 165 | 165 |
| [° C.] | | | | | | | |
| Time at max. temperature | 6 | 6 | 6 | 6 | 6 | 6 | 6 |
| [min.] | | | | | | | |
| Cooling on roller [° C.] | <60 | <60 | <60 | <60 | <60 | <60 | <60 |

TABLE 1.4
3rd mixing stage (roller)

| Compound No. | 1.1 | 1.2* | 1.3* | 1.4* | 1.5 | 1.6 | 1.7* |
|---|---|---|---|---|---|---|---|
| sulphur | 2.0 | 2.0 | 20 | 2.0 | 2.0 | 2.0 | 2.0 |
| Rhenogran ® DPG-80 | 2.5 | 2.5 | 2.5 | 2.5 | 2.5 | 2.5 | 2.5 |
| Vulkacit ® NZ/EGC | 2.0 | 2.0 | 2.0 | 2.0 | 2.0 | 2.0 | 2.0 |
| Maximum temperature | 60 | 60 | 60 | 60 | 60 | 60 | 60 |
| [° C.] | | | | | | | |

Using the unvulcanized rubber mixtures, the Mooney viscosity and the Mooney relaxation after 10 and 30 sec were determined.

TABLE 1.5

| Compound No. | 1.1 | 1.2* | 1.3* | 1.4* | 1.5 | 1.6 | 1.7* |
|---|---|---|---|---|---|---|---|
| ML 1 + 1 (100° C.) [ME] | 90.9 | 101.5 | 94.9 | 88.2 | 85.2 | 84.7 | 94.0 |
| ML 1 + 4 (100° C.) [ME] | 77.2 | 84.8 | 79.7 | 73.5 | 70.9 | 69.4 | 78.1 |
| Mooney relaxation/10 sec. | 23.8 | 24.5 | 24.2 | 23.7 | 23.5 | 23.8 | 24.1 |
| [%] | | | | | | | |
| Mooney relaxation/30 sec. | 18.3 | 19.1 | 18.8 | 18.4 | 18.1 | 18.2 | 18.9 |
| [%] | | | | | | | |

The vulcanization characteristics of the mixtures were studied in a rheometer at 160° C. to DIN 53 529 with the aid of the MDR 2000E Monsanto rheometer.

TABLE 1.6

| Compound No. | 1.1 | 1.2* | 1.3* | 1.4* | 1.5 | 1.6 | 1.7* |
|---|---|---|---|---|---|---|---|
| F_{min.} [dNm] | 4.35 | 5.12 | 4.76 | 4.28 | 4.22 | 3.81 | 4.71 |
| Fₘₐₓ [dNm] | 21.09 | 22.56 | 21.59 | 19.88 | 19.76 | 19.96 | 20.22 |
| Fₘₐₓ − F_{min.} [dNm] | 16.74 | 17.44 | 16.83 | 15.60 | 15.54 | 16.15 | 15.51 |
| t₁₀ [sec] | 115 | 115 | 105 | 89 | 82 | 60 | 86 |
| t₅₀ [sec] | 192 | 179 | 161 | 137 | 129 | 105 | 130 |
| t₉₀ [sec] | 715 | 516 | 399 | 264 | 213 | 144 | 206 |
| t₉₅ [sec] | 1011 | 728 | 578 | 369 | 271 | 161 | 261 |
| t₉₀ − t₁₀ [sec] | 600 | 401 | 294 | 175 | 131 | 84 | 120 |
| F_{15 min.} [dNm] | 20.00 | 22.07 | 21.36 | 19.86 | 19.61 | 16.97 | 20.13 |
| F_{20 min.} [dNm] | 20.56 | 22.40 | 21.54 | 19.85 | 19.44 | 16.29 | 20.01 |
| F_{25 min.} [dNm] | 20.89 | 22.54 | 21.56 | 19.92 | 19.26 | 15.87 | 19.87 |
| F_{25 min} − Fₘₐₓ [dNm] | −0.2 | −0.02 | −0.03 | 0.04 | −0.5 | −4.09 | −0.35 |

The specimens needed for the vulcanizate characterization were produced by press vulcanization under the following conditions:

TABLE 1.7

| Compound No. | 1.1 | 1.2* | 1.3* | 1.4* | 1.5 | 1.6 | 1.7* |
|---|---|---|---|---|---|---|---|
| Temperature [° C.] | 160 | 160 | 160 | 160 | 160 | 160 | 160 |
| Time [min.] | 30 | 26 | 23 | 20 | 18 | 16 | 18 |

The vulcanizate properties are summarized in the table below

TABLE 1.8

| Compound No. | 1.1 | 1.2* | 1.3* | 1.4* | 1.5 | 1.6 | 1.7* |
|---|---|---|---|---|---|---|---|
| Shore A hardness at 23° C. | 68.8 | 68.0 | 66.7 | 67.6 | 65.5 | 66.7 | 65.8 |
| DIN 53505 | | | | | | | |
| Shore A hardness at 70° C. | 59.5 | 62.2 | 59.8 | 60.2 | 60.3 | 58 | 62 |
| DIN 53505 | | | | | | | |
| Resilience/0° C. | 20.0 | 31.5 | 30.0 | 29.5 | 28.0 | 23.7 | 23.5 |
| DIN 53512 [%] [%] | | | | | | | |
| Resilience/23° C. | 45.6 | 45.2 | 44.4 | 42.5 | 41.9 | 36.7 | 46.1 |
| DIN 53512 [%] [%] | | | | | | | |
| Resilience/70° C. | 56.4 | 57.1 | 56.9 | 54.8 | 53.5 | 48.1 | 54.8 |
| DIN 53512 [%] [%] | | | | | | | |
| Resilience/100° C. | 62.3 | 62.4 | 61.8 | 60.1 | 58.2 | 51.7 | 59.2 |
| DIN 53512 [%] [%] | | | | | | | |
| σ₁₀ DIN 53504 [MPa] | 0.6 | 0.6 | 0.6 | 0.6 | 0.6 | 0.7 | 0.6 |
| σ₂₅ DIN 53504 [MPa] | 1.1 | 1.0 | 1.0 | 1.0 | 1.0 | 1.1 | 1.0 |
| σ₅₀ DIN 53504 [MPa] | 1.6 | 1.5 | 1.5 | 1.6 | 1.5 | 1.7 | 1.5 |
| σ₁₀₀ DIN 53504 [MPa] | 3.2 | 2.8 | 2.8 | 2.8 | 2.8 | 3.1 | 2.6 |
| σ₃₀₀ DIN 53504 [MPa] | 17.2 | 15.0 | 15.1 | 14.6 | 14.5 | 14.5 | 13.6 |
| Tensile strength DIN | 17.4 | 15.5 | 16.4 | 18.0 | 18.0 | 21.2 | 13.5 |
| 53504 [MPa] | | | | | | | |
| Elongation at break DIN | 301 | 311 | 318 | 365 | 357 | 430 | 298 |
| 53504 [MPa] | | | | | | | |
| Abrasion DIN 53516 | 80 | 52 | 50 | 56 | 54 | 83 | 38 |
| [mm3] | | | | | | | |
| E′ (−60° C.)/10 Hz [MPa] | 3019 | 990 | 1252 | 1318 | 1735 | 2833 | 521 |
| E′ (−50° C.)/10 Hz [MPa] | 1776 | 308 | 342 | 328 | 439 | 677 | 147 |
| E′ (−40° C.)/10 Hz [MPa] | 663 | 110 | 113 | 98 | 120 | 176 | 62.0 |
| E′ (−30° C.)/10 Hz [MPa] | 140 | 52.3 | 54.6 | 47.8 | 55.1 | 83.7 | 37.5 |
| E′ (−20° C.)/10 Hz [MPa] | 53.1 | 32.2 | 33.3 | 29.9 | 33.9 | 54.4 | 25.9 |
| E′ (−10° C.)/10 Hz [MPa] | 30.0 | 23.1 | 23.8 | 21.5 | 24.2 | 40.5 | 20.1 |
| E′ (0° C.)/10 Hz [MPa] | 20.79 | 18.04 | 18.52 | 16.94 | 18.65 | 32.29 | 16.43 |
| E′ (60° C.)/10 Hz [MPa] | 8.14 | 8.26 | 8.49 | 7.35 | 7.95 | 13.46 | 8.03 |
| E″ (60° C.)/10 Hz [MPa] | 0.85 | 0.84 | 0.87 | 0.79 | 0.92 | 1.71 | 0.86 |
| tan δ (60° C.)/10 Hz | 0.104 | 0.102 | 0.102 | 0.107 | 0.115 | 0.127 | 0.107 |

The 1st mixture series shows that, in the event of variation of the ratio of solution SBR, 1,4-cis-polybutadiene and NR using the S-SBR type VSL 2525-0 M with Tg=−49° C., only in the case of the inventive examples 1.2*, 1.3*, 1.4* and 1.7* are positive properties obtained with regard to reversion resistance, storage modulus (E′), tan δ(60° C.) and abrasion resistance. In the inventive examples, the natural rubber content is below 45 parts by weight (10 to 35 parts by weight) and the matrix Tg is in the range of −73.0° C. to −84.1° C. In the case of a noninventive glass transition temperature of the rubber matrix of −58.4° C. (noninventive example 1.1), DIN abrasion and storage moduli (E′) at −60° C., −50° C. and −40° C. are unsatisfactory. In the case of noninventive examples 1.5 and 1.6 with NR contents of 45 and 80 parts by weight, the vulcanization level decreases again after attainment of the maximum (reversion). This is an indication of poor ageing characteristics (decline in modulus during service life). In addition, in noninventive examples 1.5 and 1.6, tan δ (60° C.) is unsatisfactory. In the inventive examples with NR contents of 10 to 35 parts by weight, reversion resistances are adequate.

2nd Mixture Series

In mixing series 2), variation in the ratios of solution SBR, cis-1,4-polybutadiene and natural rubber resulted in variation of the glass transition temperatures of the rubber matrix between −43.8° C. and 87.3° C. (see Table 2.1 below). In noninventive examples 2.1, 2.2, 2.3, 2.4 and 2.7, the calculated glass transition temperature of the rubber matrix is −43.8° C., −61.2° C., −61.3° C., −61.5 and −63.6° C. Noninventive examples 2.7 and 2.8 contain NR in amounts of 70 and 80 parts by weight. Only in inventive examples 2.5* and 2.6* are both the glass transition temperature of the rubber matrix and the NR content within the inventive range.

TABLE 2.1
Glass transition temperature of the rubber matrix

| Compound No. | 2.1 | 2.2 | 2.3 | 2.4 | 2.5* | 2.6* | 2.7 | 2.8 |
|---|---|---|---|---|---|---|---|---|
| Buna ® VSL | 70 | 50 | 45 | 30 | 30 | 20 | 20 | 10 |
| 5025-0 HM | | | | | | | | |
| Buna ® CB 24 | 20 | 40 | 35 | 25 | 50 | 70 | 10 | 40 |
| TSR/RSS 3 | 10 | 10 | 20 | 45 | 20 | 10 | 70 | 50 |
| DEFO 1000 | | | | | | | | |
| Matrix Tg | −43.8 | −61.2 | −61.3 | −63.6 | −74.3 | −87.3 | −61.5 | −78.8 |

TABLE 2.2
1st mixing stage in the internal mixer

| | | | | | | | | |
|---|---|---|---|---|---|---|---|---|
| Compound No. | 2.1 | 2.2 | 2.3 | 2.4 | 2.5* | 2.6* | 2.7 | 2.8 |

Time of addition: 0 sec.

| | | | | | | | | |
|---|---|---|---|---|---|---|---|---|
| Buna ® VSL | 70 | 50 | 45 | 30 | 30 | 20 | 20 | 10 |
| 5025-0 HM | | | | | | | | |
| Buna ® CB 24 | 20 | 40 | 35 | 25 | 50 | 70 | 10 | 40 |
| TSR/RSS 3 | 10 | 10 | 20 | 45 | 20 | 10 | 70 | 50 |
| DEFIO 1000 | | | | | | | | |

Time of addition: 30 sec.

| | | | | | | | | |
|---|---|---|---|---|---|---|---|---|
| Ultrasil ® VN3 | 53 | 53 | 53 | 53 | 53 | 53 | 53 | 53 |
| BR microgel | 10 | 10 | 10 | 10 | 10 | 10 | 10 | 10 |
| Vulkanox ® | 1.0 | 1.0 | 1.0 | 1.0 | 1.0 | 1.0 | 1.0 | 1.0 |
| HS/LG | | | | | | | | |
| Vulkanox ® | 1.0 | 1.0 | 1.0 | 1.0 | 1.0 | 1.0 | 1.0 | 1.0 |
| 4020/LG | | | | | | | | |
| stearic acid | 1.0 | 1.0 | 1.0 | 1.0 | 1.0 | 1.0 | 1.0 | 1.0 |
| ozone wax | 1.4 | 1.4 | 1.4 | 1.4 | 1.4 | 1.4 | 1.4 | 1.4 |
| Si75 | 3.2 | 3.2 | 3.2 | 3.2 | 3.2 | 3.2 | 3.2 | 3.2 |

TABLE 2.2
1st mixing stage in the internal mixer
Time of addition: 90 sec.

| | | | | | | | | |
|---|---|---|---|---|---|---|---|---|
| Ultrasil ® VN3 | 27 | 27 | 27 | 27 | 27 | 27 | 27 | 27 |
| mineral oil | 20 | 20 | 20 | 20 | 20 | 20 | 20 | 20 |
| carbon black | 12 | 12 | 12 | 12 | 12 | 12 | 12 | 12 |

Time of addition: 150 sec.

| | | | | | | | | |
|---|---|---|---|---|---|---|---|---|
| zinc oxide | 2.5 | 2.5 | 2.5 | 2.5 | 2.5 | 2.5 | 2.5 | 2.5 |

Heating from 210 sec.

| | | | | | | | | |
|---|---|---|---|---|---|---|---|---|
| Maximum | 165 | 165 | 165 | 165 | 165 | 165 | 165 | 165 |
| temperature [° C.] | | | | | | | | |
| Time at max. | 6 | 6 | 6 | 6 | 6 | 6 | 6 | |
| temperature [min] | | | | | | | | 6 |
| Cooling on roller | <90 | <90 | <90 | <90 | <90 | <90 | <90 | <90 |
| [° C.] | | | | | | | | |
| Storage at 23° C. | 24 | 24 | 24 | 24 | 24 | 24 | 24 | 24 |
| [h] | | | | | | | | |

TABLE 2.3
2nd mixing stage in the internal mixer

| Compound No. | 2.1 | 2.2 | 2.3 | 2.4 | 2.5* | 2.6* | 2.7 | 2.8 |
|---|---|---|---|---|---|---|---|---|
| Si75 | 3.2 | 3.2 | 3.2 | 3.2 | 3.2 | 3.2 | 3.2 | 3.2 |
| Maximum | 150 | 150 | 150 | 150 | 150 | 150 | 150 | 150 |
| temperature [° C.] | | | | | | | | |
| Time at max. | 6 | 6 | 6 | 6 | 6 | 6 | 6 | 6 |
| temperature [min] | | | | | | | | |
| Cooling on roller | <60 | <60 | <60 | <60 | <60 | <60 | <60 | <60 |
| [° C.] | | | | | | | | |

TABLE 2.4
3rd mixing stage (roller)

| Compound No. | 2.1 | 2.2 | 2.3 | 2.4 | 2.5* | 2.6* | 2.7 | 28 |
|---|---|---|---|---|---|---|---|---|
| sulphur ¹⁷⁾ | 2.0 | 2.0 | 2.0 | 2.0 | 2.0 | 2.0 | 2.0 | 2.0 |
| Rhenogran | 2.5 | 2.5 | 2.5 | 2.5 | 2.5 | 2.5 | 2.5 | 2.5 |
| DPG-80 | | | | | | | | |
| Vulkacit ® | 2.0 | 2.0 | 2.0 | 2.0 | 2.0 | 2.0 | 2.0 | 2.0 |
| NZ/EGC | | | | | | | | |
| Maximum tem- | 60 | 60 | 60 | 60 | 60 | 60 | 60 | 60 |
| perature [° C.] | | | | | | | | |

Using the unvulcanized rubber mixtures, the Mooney viscosity and the Mooney relaxation after 10 and 30 sec were determined.

TABLE 2.5

| Compound No. | 2.1 | 2.2 | 2.3 | 2.4 | 2.5* | 2.6* | 2.7 | 2.8 |
|---|---|---|---|---|---|---|---|---|
| ML 1 + 1 (100° C.) [ME] | 114.0 | 117.5 | 109.1 | 94.7 | 115.1 | 123 | 96.4 | 102.9 |
| ML 1 + 4 (100° C.) [ME] | 91.4 | 94.1 | 88.5 | 75.3 | 91.7 | 98.0 | 76.02 | 81.5 |
| Mooney relaxation/10 sec. [%] | 25.4 | 26.0 | 25.5 | 23.8 | 26.3 | 26.5 | 25.1 | 25.9 |
| Mooney relaxation/30 sec. [%] | 19.7 | 20.4 | 20.0 | 18.2 | 20.9 | 21.1 | 19.3 | 20.5 |

The vulcanization characteristics of the mixtures were studied in a rheometer at 160° C. to DIN 53 529 with the aid of the MDR 2000E Monsanto rheometer.

TABLE 2.6
Vulcanization characteristics

| Compound No. | 2.1 | 2.2 | 2.3 | 2.4 | 2.5* | 2.6* | 2.7 | 2.8 |
|---|---|---|---|---|---|---|---|---|
| F_{min.} [dNm] | 4.43 | 4.88 | 4.60 | 3.57 | 5.0 | 5.3 | 3.6 | 4.2 |
| Fₘₐₓ [dNm] | 23.05 | 23.2 | 21.88 | 18.68 | 21.64 | 22.35 | 18.94 | 19.2 |
| Fₘₐₓ − F_{min.} [dNm] | 18.62 | 18.32 | 17.28 | 15.11 | 16.64 | 17.05 | 15.34 | 15.0 |
| t₁₀ [sec] | 137 | 121 | 114 | 94 | 100 | 108 | 72 | 78 |
| t₅₀ [sec] | 234 | 193 | 174 | 140 | 151 | 159 | 114 | 119 |
| t₉₀ [sec] | 744 | 528 | 385 | 220 | 302 | 271 | 165 | 166 |
| t₉₅ [sec] | 1012 | 745 | 545 | 266 | 432 | 366 | 188 | 188 |
| t₉₀-t₁₀ [sec] | 607 | 407 | 271 | 146 | 202 | 163 | 93 | 88 |
| F_{15 min.} [dNm] | 21.82 | 22.63 | 21.67 | 18.50 | 21.56 | 22.34 | 17.40 | 18.13 |
| F_{20 min.} [dNm] | 22.49 | 23.01 | 21.81 | 18.31 | 21.62 | 22.27 | 16.94 | 17.73 |
| F_{25 min.} [dNm] | 22.86 | 23.13 | 21.86 | 18.15 | 21.60 | 22.17 | 16.61 | 17.47 |
| F_{25 min.} − Fₘₐₓ [dNm] | −0.19 | −0.07 | −0.02 | −0.53 | −0.04 | −0.18 | −2.33 | −1.73 |

The specimens needed for the vulcanizate characterization were produced by press vulcanization under the following conditions:

TABLE 2.7
Vulcanization time

| Compound No. | 2.1 | 2.2 | 2.3 | 2.4 | 2.5* | 2.6* | 2.7 | 2.8 |
|---|---|---|---|---|---|---|---|---|
| Temperature [° C.] | 160 | 160 | 160 | 160 | 160 | 160 | 160 | 160 |
| Time [min.] | 30 | 26 | 23 | 18 | 21 | 20 | 17 | 17 |

The vulcanizate properties are summarized in the table below

TABLE 2.8
Vulcanizate properties

| Compound No. | 2.1 | 2.2 | 2.3 | 2.4 | 2.5* | 2.6* | 2.7 | 2.8 |
|---|---|---|---|---|---|---|---|---|
| Shore A hardness at 23° C. | 68.5 | 68.9 | 68.8 | 65.6 | 66.6 | 67.2 | 66.3 | 64.9 |
| DIN 53505 | | | | | | | | |
| Shore A hardness at 70° C. | 62.0 | 60.7 | 61.0 | 56.2 | 58.0 | 59.0 | 56.0 | 54.2 |
| DIN 53505 | | | | | | | | |
| Resilience/0° C. | 9.0 | 18.0 | 18.8 | 21.0 | 27.0 | 35.0 | 19.0 | 30.5 |
| DLN 53512 [%] [%] | | | | | | | | |
| Resilience/23° C. | 28.6 | 37.5 | 38.2 | 37.6 | 42.8 | 47.3 | 34.3 | 42.8 |
| DIN 53512 [%] [%] | | | | | | | | |
| Resilience/70° C. | 59.5 | 59.6 | 60.4 | 57.3 | 58.9 | 60.3 | 52.1 | 54.5 |
| DIN 53512 [%] [%] | | | | | | | | |
| Resilience/100° C. | 66.3 | 65.2 | 64.3 | 61.7 | 63.2 | 63.5 | 57.3 | 59.2 |
| DIN 53512 [%] [%] | | | | | | | | |
| σ₁₀ DIN 53504 [MPa] | 0.6 | 0.6 | 0.6 | 1 0.6 | 0.6 | 1 0.6 | 0.7 | 0.6 |
| σ₂₅ DIN 53504 [MPa] | 1.1 | 1.1 | 1.0 | 1.0 | 1.1 | 1.1 | 1.1 | 1.0 |
| σ₅₀ DIN 53504 [MPa] | 1.7 | 1.6 | 1.6 | 1.6 | 1.6 | 1.6 | 1.7 | 1.5 |
| σ₁₀₀ DIN 53504 [MPa] | 3.5 | 3.1 | 3.1 | 2.9 | 3.0 | 2.7 | 3.2 | 2.7 |
| σ₃₀₀ DIN 53504 [MPa] | — | 17.4 | 17.2 | 15.8 | 16.3 | 15.0 | 16.1 | 14.6 |
| Tensile strength DIN 53504 | 17.8 | 18.1 | 17.7 | 19.4 | 16.9 | 17.9 | 21.2 | 14.6 |
| [MPa] | | | | | | | | |
| Elongation at break DIN | 271 | 310 | 311 | 359 | 306 | 336 | 390 | 301 |
| 53504 [MPa] | | | | | | | | |
| Abrasion DIN 53516 [mm3] | 92 | 62 | 61 | 67 | 43 | 31 | 73 | 43 |
| E′ (−60° C.)/10 Hz [MPa] | 2042 | 1781 | 1930 | 2383 | 1016 | 315 | 3280 | 1181 |
| E′ (−50° C.)/10 Hz [MPa] | 1708 | 993 | 1061 | 950 | 405 | 153 | 1270 | 319 |
| E′ (−40° C.)/10 Hz [MPa] | 1272 | 447 | 416 | 301 | 162 | 83.7 | 346 | 108 |
| E′ (−30° C.)/10 Hz [MPa] | 823 | 178 | 155 | 112 | 74.9 | 47.3 | 135 | 53.7 |
| E′ (−20° C.)/10 Hz [MPa] | 281 | 78.6 | 69.9 | 53.7 | 42.8 | 29.1 | 71.1 | 34.1 |
| E′ (−10° C.)/10 Hz [MPa] | 85.1 | 40.4 | 36.2 | 31.7 | 28.2 | 21.5 | 44.8 | 24.8 |
| E′ (0° C.)/10 Hz [MPa] | 35.3 | 25.3 | 22.9 | 21.7 | 20.7 | 17.1 | 31.5 | 19.6 |
| tan δ (60° C.)/10 Hz | 0.096 | 0.095 | 0.093 | 0.104 | 0.101 | 0.097 | 0.118 | 0.115 |

The 2nd mixture series shows that, in the event of variation in the ratios of solution SBR, 1,4-cis-polybutadiene and NR using the S-SBR type Buna® VSL 5025-0 HM with Tg=−22° C., a satisfactory combination of properties is obtained only when both the glass transition temperature of the rubber matrix and the natural rubber content are within the inventive range. At glass transition temperatures of the rubber matrix of −43.8° C. (noninventive example 2.1), −61.2° C. (noninventive example 2.2), and −61.3° C. (noninventive example 2.3), satisfactory properties are not obtained, even though the NR content in these examples is within the inventive range. In these examples, DIN abrasion is too high. In addition, in these examples, the storage modulus E′ is not adequate for all examples. In noninventive examples 2.4, 2.7 and 2.8 with NR contents of 45, 70 and 50 parts by weight, the reversion resistance of the rubber mixtures is inadequate. In the case of noninventive examples 2.7 and 2.8 too, tan δ at 60° C. (rolling resistance) of the vulcanizates is unsatisfactory. In addition, in noninventive example 2.7, the storage modulus E′(−60° C.). E′(−50° C.), E′(−20° C.), E′(0° C.) and the abrasion resistance are inadequate. In inventive examples 2.5* and 2.6*, reversion resistance, storage moduli in the temperature range of −60° C. to 0° C., rolling resistance and abrasion characteristics are satisfactory.

3rd Mixture Series

In the 3rd mixture series, at a constant mixing ratio of S-SBR, Nd-BR and NR, the S-SBR type is varied. As a result of this measure, the calculated glass transition temperature of the rubber matrix varies between −57.2° C. and −73.4° C. In addition, for the same composition of the rubber matrix, the properties of microgel-containing and microgel-free rubber mixtures (10 phr microgel) are compared. Only for the microgel-containing rubber mixture of Inventive example 3.6* with a matrix Tg=−73.4° C. is the combination of advantageous properties required found.

TABLE 3.1
Glass transition temperature of the rubber matrix

| Compound No | 3.1 | 3.2 | 3.3 | 3.4 | 3.5 | 3.6* | 3.7 | 3.8 |
|---|---|---|---|---|---|---|---|---|
| Buna ® VSL5025-2 HM | 61.88 | 61.88 | — | — | — | — | — | — |
| Buna ® VSL 5228-2 | — | — | 61.88 | 61.88 | — | — | — | — |
| Buna ® VSL 2.525-0 M | — | — | — | — | 45.0 | 45.0 | — | — |
| Buna ® VSL 5025-0 HM | — | — | — | — | — | — | 45.0 | 45.0 |
| Buna ® CB 24 | 35 | 35 | 35 | 35 | 35 | 35 | 35 | 35 |
| TSR/RSS 3 DEFO 1000 | 20 | 20 | 20 | 20 | 20 | 20 | 20 | 20 |

| | | | | |
|---|---|---|---|---|
| Matrix Tg [° C.] | −61.25 | −57.20 | −73.4 | −61.25 |

TABLE 3.2
1st mixing stage (internal mixer)

| | | | | | | | | |
|---|---|---|---|---|---|---|---|---|
| Compound No. | 3.1 | 3.2 | 3.3 | 3.4 | 3.5 | 3.6* | 3.7 | 3.8 |

Time of addition: 0 sec.

| | | | | | | | | |
|---|---|---|---|---|---|---|---|---|
| Buna ® VSL5025-2 HM | 61.88 | 61.88 | — | — | — | — | — | — |
| Buna ® VSL 5228-2 | — | — | 61.88 | 61.88 | — | — | — | — |
| Buna ® VSL 2525-0 HM | — | — | — | — | 45.0 | 45.0 | — | — |
| Buna ® VSL 5025-0 HM | — | — | — | — | — | — | 45.0 | 45.0 |
| Buna ® CB 24 | 35 | 35 | 35 | 35 | 35 | 35 | 35 | 35 |
| TSR/RSS 3 DEFO 1000 | 20 | 20 | 20 | 20 | 20 | 20 | 20 | 20 |

Time of addition: 60 sec.

| | | | | | | | | |
|---|---|---|---|---|---|---|---|---|
| Ultrasil ® 7000 GR | 80 | 80 | 80 | 80 | 80 | 80 | 80 | 80 |
| Si 75 | 6.5 | 6.5 | 6.5 | 6.5 | 6.5 | 6.5 | 6.5 | 6.5 |
| carbon black | 12 | 12 | 12 | 12 | 12 | 12 | 12 | 12 |
| BR microgel | — | 10 | — | 10 | — | 10 | — | 10 |

Heating 65-90 sec.

| | | | | | | | | |
|---|---|---|---|---|---|---|---|---|
| Maximum temperature [° C.] | 140 | 140 | 140 | 140 | 140 | 140 | 140 | 140 |
| Time at max. temperature [sec.] | 120 | 120 | 120 | 120 | 120 | 120 | 120 | 120 |

Addition: 210 sec.

| | | | | | | | | |
|---|---|---|---|---|---|---|---|---|
| mineral oil | 20 | 20 | 20 | 20 | 30 | 30 | 30 | 30 |
| Vulkanox ® HS/LG | 2.0 | 2.0 | 2.0 | 2.0 | 2.0 | .0 | 2.0 | 2.0 |
| Vulkanox ® 4020/LG | 1.0 | 1.0 | 1.0 | 1.0 | 1.0 | 1.0 | 1.0 | 1.0 |
| ozone wax | 2.0 | 2.0 | 2.0 | 2.0 | 2.0 | 2.0 | 2.0 | 2.0 |
| stearic acid | 1.0 | 1.0 | 1.0 | 1.0 | 1.0 | 1.0 | 1.0 | 1.0 |
| zinc oxide | 2.5 | 2.5 | 2.5 | 2.5 | 2.5 | 2.5 | 2.5 | 2.5 |
| Rhenogran ® DPG-80 | 2.5 | 2.5 | 2.5 | 2.5 | 2.5 | 2.5 | 2.5 | 2.5 |

Ejection 300 sec.

| | | | | | | | | |
|---|---|---|---|---|---|---|---|---|
| Cooling and storage at 23° C. [h] | 24 | 24 | 24 | 24 | 24 | 24 | 24 | 24 |

TABLE 3.3
2nd mixing stage (internal mixer)

| Compound No. | 3.1 | 3.2 | 3.3 | 3.4 | 3.5 | 3.6* | 3.7 | 3.8 |
|---|---|---|---|---|---|---|---|---|
| Maximum temperature [° C.] | 140 | 140 | 140 | 140 | 140 | 140 | 140 | 140 |
| Time at max. temperature [sec.] | 120 | 120 | 120 | 120 | 120 | 120 | 120 | 120 |
| Cooling on roller | <60 | <60 | <60 | <60 | <60 | <60 | <60 | <60 |

TABLE 3.4
3rd mixing stage (roller)

| Compound No. | 3.1 | 3.2 | 3.3 | 3.4 | 3.5 | 3.6* | 3.7 | 3.8 |
|---|---|---|---|---|---|---|---|---|
| sulphur | 2.0 | 2.0 | 2.0 | 2.0 | 2.0 | 2.0 | 2.0 | 2.0 |
| Vulkacit ® | 2.0 | 2.0 | 2.0 | 2.0 | 2.0 | 2.0 | 2.0 | 2.0 |
| NZ/EGC | | | | | | | | |
| Maximum tem- | 60 | 60 | 60 | 60 | 60 | 60 | 60 | 60 |
| perature [° C.] | | | | | | | | |

Using the unvulcanized rubber mixture, the Mooney viscosity and the Mooney relaxation after 10 and 30 sec were determined.

TABLE 3.5

| Compound No | 3.1 | 3.2 | 3.3 | 3.4 | 3.5 | 3.6* | 3.7 | 3.8 |
|---|---|---|---|---|---|---|---|---|
| ML 1 + 1 (100° C.) [ME] | 60.7 | 69.4 | 61.2 | 67.8 | 59.7 | 64.7 | 57.3 | 64.3 |
| ML 1 + 4 (100° C.) [ME] | 53.8 | 62.1 | 54.1 | 60.7 | 51.8 | 56.8 | 49.5 | 56.8 |
| Mooney relaxation/10 sec. [%] | 17.1 | 18.1 | 17.9 | 18.6 | 18.4 | 18.5 | 16.0 | 16.2 |
| Mooney relaxation/30 sec. [%] | 11.6 | 12.4 | 12.3 | 13.1 | 13.4 | 13.5 | 11.1 | 11.3 |

The vulcanization characteristics of the mixtures were studied in a rheometer at 160° C. to DIN 53 529 with the aid of the MDR 2000E Monsanto rheometer.

TABLE 3.6

| Compound No. | 3.1 | 3.2 | 3.3 | 3.4 | 3.5 | 3.6* | 3.7 | 3.8 |
|---|---|---|---|---|---|---|---|---|
| F_{min.} [dNm] | 2.36 | 2.93 | 2.21 | 2.77 | 2.28 | 2.89 | 1.99 | 2.67 |
| Fₘₐₓ [dNm] | 21.62 | 18.11 | 19.5 | 17.9 | 22.03 | 20.71 | 21.86 | 20.26 |
| Fₘₐₓ − F_{min.} [dNm] | 19.27 | 15.18 | 17.29 | 15.13 | 19.75 | 17.82 | 19.87 | 17.59 |
| t₁₀ [sec] | 125 | 164 | 148 | 172 | 125 | 133 | 142 | 152 |
| t₅₀ [sec] | 265 | 347 | 320 | 363 | 294 | 31 1 | 309 | 326 |
| t₉₀ [sec] | 463 | 554 | 535 | 584 | 455 | 495 | 540 | 580 |
| t₉₅ [sec] | 618 | 711 | 698 | 755 | 576 | 634 | 714 | 769 |
| t₉₀-t₁₀ [sec] | 338 | 390 | 387 | 312 | 330 | 362 | 298 | 328 |
| F_{15 min.} [dNm] | 21.36 | 17.75 | 19.10 | 14.47 | 21.87 | 20.47 | 21.37 | 19.70 |
| F_{20 min.} [dNm] | 21.58 | 18.02 | 19.45 | 17.80 | 22 | 20.68 | 21.76 | 20.12 |
| F_{25 min.} [dNm] | 21.59 | 18.09 | 19.47 | 17.89 | 21.96 | 20.68 | 21.85 | 20.22 |
| F_{25 min} − Fₘₐₓ [dNm] | −0.03 | −0.02 | −0.03 | −0.01 | −0.07 | −0.03 | −0.01 | −0.04 |

The specimens needed for the vulcanizate characterization were produced by press vulcanization under the following conditions:

TABLE 3.7
Vulcanization time

| Compound No. | 3.1 | 3.2 | 3.3 | 3.4 | 3.5 | 3.6* | 3.7 | 3.8 |
|---|---|---|---|---|---|---|---|---|
| Temperature [° C.] | 160 | 160 | 160 | 160 | 160 | 160 | 160 | 160 |
| Time [min.] | 30 | 30 | 30 | 30 | 30 | 30 | 30 | 30 |

The vulcanizate properties are summarized in the table below

TABLE 3.8
Vulcanizate properties

| Compound No. | 3.1 | 3.2 | 3.3 | 3.4 | 3.5 | 3.6* | 3.7 | 3.8 |
|---|---|---|---|---|---|---|---|---|
| Shore A hardness at 23° C. DIN 53505 | 63.6 | 60.4 | 61.9 | 61.2 | 65.5 | 62.9 | 64.7 | 64.3 |
| Shore A hardness at 70° C. DIN 53505 | 63.3 | 58 | 57.3 | 57.5 | 59.7 | 58.0 | 59 | 58 |
| Resilience/23° C. DIN 53512 [%] [%] | 33.9 | 38.4 | 30.1 | 35.2 | 38.1 | 42.7 | 31.9 | 36.3 |
| Resilience/70° C. DIN 53512 [%] [%] | 57.2 | 58.0 | 55.2 | 58.0 | 50.9 | 56.5 | 52.2 | 57.9 |
| Tear propagation resistance/23° C. | 53.4 | 60.7 | 60.9 | 65.8 | 46.7 | 50.5 | 46.8 | 41.6 |
| [N/mm] | | | | | | | | |
| Tear propagation resistance/70° C. | 29.8 | 39.1 | 25.5 | 31.3 | 36.9 | 35.0 | 33.6 | 29.8 |
| [N/mm] | | | | | | | | |
| σ₁₀ DIN 53504 [MPa] | 0.6 | 0.5 | 0.6 | 0.5 | 0.6 | 0.6 | 0.7 | 0.6 |
| σ₂₅ DIN 53504 [MPa] | 1.0 | 0.8 | 0.9 | 0.9 | 1.0 | 0.9 | 1.0 | 1.0 |
| σ₅₀ DIN 53504 [MPa] | 1.4 | 1.3 | 1.3 | 1.3 | 1.3 | 1.4 | 1.4 | 1.5 |
| σ₁₀₀ DIN 53504 [MPa] | 2.5 | 2.3 | 2.3 | 2.5 | 2.1 | 2.3 | 2.4 | 2.6 |
| σ₃₀₀ DIN 53504 [MPa] | 2.1 | 11.5 | 11.3 | 11.9 | 9.7 | 11.0 | 11.4 | 12.5 |
| σ₃₀₀/σ₂₅ | 12.1 | 14.4 | 12.6 | 13.2 | 9.7 | 12.2 | 11.4 | 12.5 |
| Tensile strength DIN 53504 [MPa] | 18.0 | 18.6 | 18.6 | 17.2 | 19.5 | 19.2 | 20.1 | 17.6 |
| Elongation at break DIN 53504 [MPa] | 397 | 448 | 438 | 404 | 484 | 459 | 449 | 396 |
| Abrasion DIN 53516 [mm3] | 65 | 58 | 63 | 64 | 48 | 36 | 63 | 59 |

TABLE 3.9
Temperature dependence of E′/Eplexor test* (heating rate: 1 K/min)

| Compound No. | 3.1 | 3.2 | 33 | 3.4 | 3.5 | 3.6* | 3.7 | 3.8 |
|---|---|---|---|---|---|---|---|---|
| E′ (−60° C.)/10 Hz [MPa] | 2277 | 2171 | 2397 | 2269 | 1513 | 1434 | 2256 | 1974 |
| E′ (−50° C.)/10 Hz [MPa] | 1352 | 1156 | 1463 | 1316 | 571.6 | 496.2 | 1373 | 1155 |
| E′ (−40° C.)/10 Hz [MPa] | 595.5 | 436.2 | 679.5 | 580.5 | 212.7 | 166.9 | 609.4 | 486.3 |
| E′ (−30° C.)/10 Hz [MPa] | 242.9 | 153.7 | 291.4 | 226.7 | 110.9 | 80.4 | 273.4 | 196.4 |
| E′ (−20° C.)/10 Hz [MPa] | 114.9 | 66.5 | 135.5 | 94.1 | 72.6 | 49.9 | 137.2 | 89.4 |
| E′ (−10° C.)/10 Hz [MPa] | 67.8 | 35.5 | 75.3 | 48.8 | 52.8 | 36.1 | 83.6 | 50.1 |
| E′ (0° C.)/10 Hz [MPa] | 45.4 | 24.2 | 47.8 | 29.8 | 40.1 | 26.4 | 56.5 | 33.7 |
| E″ (60° C.) 10 Hz [MPa] | 1.88 | 0.8 | 1.74 | 0.92 | 2.2 | 1.21 | 2.59 | 1.21 |
| E′ (60° C.) 10 Hz [MPa] | 15.6 | 8.56 | 14.14 | 9.28 | 17.62 | 12.22 | 20.08 | 11.7 |
| tan δ (60° C.) | 0.121 | 0.094 | 0.123 | 0.099 | 0.125 | 0.099 | 0.129 | 0.103 |

In the 3rd mixture series, various solution SBR types which differ in terms of glass transition temperature are used. The ratio of solution SBR, 1,4-cis-polybutadiene and natural rubber is kept constant, and the natural rubber content is in each case 20 phr. The calculated glass transition temperatures of the rubber matrices are varied from −57.2 to −73.4° C. The 3rd mixture series shows that only in the case of Inventive example 3.6*, for which the calculated glass transition temperature of the rubber matrix is −73.4° C., are advantageous properties found in abrasion resistance and rolling resistance, with E′ within the temperature range of −60 to 0° C. The reversion resistances of all examples in the 3rd mixture series are adequate.

4th Mixture Series

In the 4th mixture series, the calculated glass transition temperature of the rubber matrix is varied within the inventive range of −70.5° C. to −75.9° C., by varying the ratios of S-SBR, high-cis-1,4 BR and NR. The high-cis BR types used are both the Nd BR type Buna® CB 24 and the Co BR type Buna® CB 1203. The S-SBRs used are both Buna® VSL 2525-0 M and Buna® VSL 5025-0 HM. In all rubber mixtures, the amount of microgel is kept constant (10 phr). The inventive combination of positive properties is found for inventive examples 4.1*, 4.2*, 4.3* 4.4*, 4.5*, and 4.6*. Due to inadequate reversion resistance, examples 4.7 and 4.8 with NR contents of 38 and 40 phr are noninventive.

TABLE 4.1
Glass transition temperature of the rubber matrix

| Compound No. | 4.1* | 4.2* | 4.3* | 4.4* | 4.5* | 4.6* | 4.7 | 4.8 |
|---|---|---|---|---|---|---|---|---|
| Buna ® VSL 2525-0 M | 30 | 30 | 10 | 20 | 35 | 22 | 20 | 15 |
| Buna ® VSL 5025-0 HM | 10 | 10 | 25 | 15 | — | 10 | 10 | 10 |
| Buna ® CB 24 | 45 | — | 40 | 35 | — | 33 | 32 | 35 |
| Buna ® CB 1203 | — | 45 | — | — | 35 | — | — | — |
| TSR/RSS 3 DEFO 1000 | 15 | 15 | 25 | 30 | 30 | 35 | 38 | 40 |
| Matrix Tg [° C.] | −75.9 | −75.0 | −70.5 | −71.1 | −74.4 | −72.1 | −72.0 | −74.1 |

TABLE 4.2
1st mixing stage (internal mixer)

| | | | | | | | | |
|---|---|---|---|---|---|---|---|---|
| Compound No. | 4.1* | 4.2* | 4.3* | 4.4* | 4.5* | 4.6* | 4.7 | 4.8 |

Time of addition: 0 sec.

| | | | | | | | | |
|---|---|---|---|---|---|---|---|---|
| Buna ® VSL 2525-0 HM | 30 | 30 | 10 | 20 | 35 | 22 | 20 | 15 |
| Buna ® VSL 5025-0 HM | 10 | 10 | 25 | 15 | | 10 | 10 | 10 |
| Buna ® CB 24 | 45 | | 40 | 35 | | 33 | 32 | 35 |
| Buna ® CB 1203 | | 45 | | | 35 | | | |
| TSR/RSS 3 DEFO 1000 | 15 | 15 | 25 | 30 | 30 | 35 | 38 | 40 |

Time of addition: 30 sec.

| | | | | | | | | |
|---|---|---|---|---|---|---|---|---|
| Ultrasil ® VN3 | 53 | 53 | 53 | 53 | 53 | 53 | 53 | 53 |
| BR microgel | 10 | 10 | 10 | 10 | 10 | 10 | 10 | 10 |
| Vulkanox ® HS/LG | 2.0 | 2.0 | 2.0 | 2.0 | 2.0 | 2.0 | 2.0 | 2.0 |
| Vulkanox ® 4020/LG | 1.0 | 1.0 | 1.0 | 1.0 | 1.0 | 1.0 | 1.0 | 1.0 |
| stearic acid | 1.0 | 1.0 | 1.0 | 1.0 | 1.0 | 1.0 | 1.0 | 1.0 |
| ozone wax | 2.0 | 2.0 | 2.0 | 2.0 | 2.0 | 2.0 | 2.0 | 2.0 |
| Si75 | 6.5 | 6.5 | 6.5 | 6.5 | 6.5 | 6.5 | 6.5 | 6.5 |

Time of addition: 90 sec.

| | | | | | | | | |
|---|---|---|---|---|---|---|---|---|
| Ultrasil ® 7000 GR | 27 | 27 | 27 | 27 | 27 | 27 | 27 | 27 |
| mineral oil | 20 | 20 | 20 | 20 | 30 | 30 | 30 | 30 |
| carbon black | 12 | 12 | 12 | 12 | 12 | 12 | 12 | 12 |

Time of addition: 150 sec.

| | | | | | | | | |
|---|---|---|---|---|---|---|---|---|
| zinc oxide | 2.5 | 2.5 | 2.5 | 2.5 | 2.5 | 2.5 | 2.5 | 2.5 |

Heating from 210 sec.

| | | | | | | | | |
|---|---|---|---|---|---|---|---|---|
| Maximum temperature [° C.] | 150 | 150 | 150 | 150 | 150 | 150 | 150 | 150 |
| Time at max. temperature [min.] | 6 | 6 | 6 | 6 | 6 | 6 | 6 | 6 |
| Cooling and storage at 23° C. [h] | 24 | 24 | 24 | 24 | 24 | 24 | 24 | 24 |

TABLE 4.3
2nd mixing stage (internal mixer)

| Compound No. | 4.1* | 4.2* | 4.3* | 4.4* | 4.5* | 4.6* | 4.7 | 4.8 |
|---|---|---|---|---|---|---|---|---|
| Maximum | 150 | 150 | 150 | 150 | 150 | 150 | 150 | 150 |
| temperature [° C.] | | | | | | | | |
| Time at max. | 6 | 6 | 6 | 6 | 6 | 6 | 6 | 6 |
| temperature [min.] | | | | | | | | |
| Cooling on roller | <60 | <60 | <60 | <60 | <60 | <60 | <60 | <60 |

TABLE 4.4
3rd mixing stage (roller)

| Compound No. | 4.1* | 4.2* | 4.3* | 4.4* | 4.5* | 4.6* | 4.7 | 4.8 |
|---|---|---|---|---|---|---|---|---|
| sulphur | 2.0 | 2.0 | 2.0 | 2.0 | 2.0 | 2.0 | 2.0 | 2.0 |
| Vulkacit ® NZ/EGC | 2.0 | 2.0 | 2.0 | 2.0 | 2.0 | 2.0 | 2.0 | 2.0 |
| Rhenogran ® DPG-80 | 2.5 | 2.5 | 2.5 | 2.5 | 2.5 | 2.5 | 2.5 | 2.5 |
| Maximum temperature [° C.] | 60 | 60 | 60 | 60 | 60 | 60 | 60 | 60 |

Using the unvulcanized rubber mixture, the Mooney viscosity and the Mooney relaxation after 10 and 30 sec were determined.

TABLE 4.5

| Compound No. | 4.1* | 4.2* | 4.3* | 4.4* | 4.5* | 4.6* | 4.7 | 4.8 |
|---|---|---|---|---|---|---|---|---|
| ML 1 + 1 (100° C.) [ME] | 113.8 | 109.4 | 119.8 | 111.0 | 97.2 | 104.5 | 106.0 | 102.5 |
| ML 1 + 4 (100° C.) [ME] | 89.1 | 87.7 | 93.9 | 87.7 | 78.2 | 83.1 | 84.8 | 82.2 |
| Mooney relaxation/ | 24.8 | 26.1 | 26.4 | 25.5 | 24.9 | 24.9 | 25.4 | 24.6 |
| 10 sec. [%] | | | | | | | | |
| Mooney relaxation/ | 15.6 | 17.1 | 17.1 | 16.2 | 16.0 | 15.5 | 16.2 | 15.2 |
| 30 sec. [%] | | | | | | | | |

The vulcanization characteristics of the mixtures were studied in a rheometer at 160° C. to DIN 53 529 with the aid of the MDR 2000E Monsanto rheometer.

TABLE 4.6

| Compound No. | 4.1* | 4.2* | 4.3* | 4.4* | 4.5* | 4.6* | 4.7 | 4.8 |
|---|---|---|---|---|---|---|---|---|
| F_{min.} [dNm] | 5.74 | 6.11 | 6.17 | 5.52 | 5.38 | 5.14 | 5.29 | 4.99 |
| Fₘₐₓ [dNm] | 23.99 | 24.24 | 24.29 | 23.44 | 22.64 | 22.57 | 23.07 | 22.50 |
| Fₘₐₓ − F_{min.} [dNm] | 18.25 | 18.13 | 18.12 | 17.92 | 17.26 | 17.43 | 17.78 | 17.51 |
| t₁₀ [sec] | 138 | 128 | 117 | 115 | 109 | 108 | 107 | 108 |
| t₅₀ [sec] | 188 | 179 | 166 | 164 | 155 | 153 | 153 | 152 |
| t₉₀ [sec] | 321 | 321 | 280 | 269 | 250 | 242 | 251 | 222 |
| t₉₅ [sec] | 408 | 414 | 354 | 338 | 310 | 297 | 314 | 264 |
| t₉₀ − t₁₀ [sec] | 183 | 193 | 163 | 154 | 141 | 134 | 114 | 114 |
| F_{15 min.} [dNm] | 23.96 | 24.22 | 24.21 | 23.29 | 22.46 | 22.29 | 22.86 | 21.94 |
| F_{20 min.} [dNm] | 23.76 | 24.17 | 24.07 | 23.08 | 22.26 | 22.25 | 22.54 | 21.62 |
| F_{25 min.} [dNm] | 23.59 | 23.89 | 23.99 | 22.97 | 22.21 | 22.15 | 22.37 | 21.43 |
| F_{25 min} − Fₘₐₓ [dNm] | −0.40 | −0.35 | −0.30 | −0.47 | −0.43 | −0.42 | −0.70 | −1.07 |

The specimens needed for the vulcanizate characterization were produced by press vulcanization under the following conditions:

TABLE 4.7
Vulcanization time

| Compound No. | 4.1* | 4.2* | 4.3* | 4.4* | 4.5* | 4.6* | 4.7 | 48 |
|---|---|---|---|---|---|---|---|---|
| Temperature | 160 | 160 | 160 | 160 | 160 | 160 | 160 | 160 |
| [° C.] | | | | | | | | |
| Time [min.] | 12 | 12 | 12 | 12 | 12 | 12 | 12 | 12 |

The vulcanizate properties are summarized in the table below

TABLE 4.8
Vulcanizate properties

| Compound No. | 4.1* | 4.2* | 4.3* | 4.4* | 4.5* | 4.6* | 4.7 | 4.8 |
|---|---|---|---|---|---|---|---|---|
| Shore A hardness at 23° C. | 68.6 | 68 | 69.4 | 68.9 | 67.2 | 68 | 67.6 | 67.5 |
| DIN 53505 | | | | | | | | |
| Shore A hardness at 70° C. | 61.5 | 64.3 | 63.7 | 60.7 | 62.7 | 62 | 62.5 | 61.7 |
| DIN 53505 | | | | | | | | |
| Resilience/23° C. | 45.6 | 43.2 | 40.5 | 42.6 | 46.1 | 43.1 | 42.7 | 44.2 |
| DIN 53512 [%] [%] | | | | | | | | |
| Resilience/70° C. | 59.4 | 59.3 | 59.9 | 59.7 | 56.8 | 58.9 | 56.9 | 58.9 |
| DIN 53512 [%] [%] | | | | | | | | |
| Tear propagation resistance/23° C. | 19.7 | 15.2 | 20.6 | 36.6 | 28.9 | 35.4 | 38.5 | 43.3 |
| [N/mm] | | | | | | | | |
| Tear propagation resistance/70° C. | 22.1 | 16.6 | 20.1 | 33.9 | 32.6 | 39.8 | 21.1 | 27.8 |
| [N/mm] | | | | | | | | |
| σ₁₀ DIN 53504 [MPa] | 0.6 | 0.6 | 0.7 | 0.6 | 0.6 | 0.6 | 0.6 | 0.6 |
| σ₂₅ DIN 53504 [MPa] | 1.1 | 1.1 | 1.1 | 1.1 | 1.1 | 1.1 | 1.1 | 1.1 |
| σ₅₀ DIN 53504 [MPa] | 1.7 | 1.7 | 1.8 | 1.7 | 1.7 | 1.7 | 1.7 | 1.7 |
| σ₁₀₀ DIN 53504 [MPa] | 3.2 | 3.5 | 3.5 | 3.3 | 3.3 | 3.1 | 3.4 | 3.2 |
| σ₃₀₀ DIN 53504 [MPa] | 17.5 | — | — | 17.4 | 16.3 | 16.2 | 16.9 | 16.3 |
| Tensile strength DIN 53504 [MPa] | 19.8 | 16.5 | 17.7 | 19.7 | 18.8 | 18.6 | 17.4 | 20.7 |
| Elongation at break DIN 53504 | 325 | 275 | 297 | 330 | 336 | 334 | 308 | 366 |
| [MPa] | | | | | | | | |
| Abrasion DIN 53516 [mm3] | 45 | 46 | 48 | 52 | 49 | 52 | 53 | 49 |

TABLE 4.9
Temperature dependence of E′/Eplexor test* (heating rate: 1 K/min)

| Compound No. | 4.1* | 4.2* | 4.3* | 4.4* | 4.5* | 4.6* | 4.7 | 4.8 |
|---|---|---|---|---|---|---|---|---|
| E′ (−60° C.)/10 Hz [MPa] | 797.5 | 831.8 | 1419 | 1442 | 1070 | 1380 | 1542 | 1317 |
| E′ (−50° C.)/10 Hz [MPa] | 261.0 | 283.4 | 554.2 | 505.6 | 304.6 | 403.3 | 458.7 | 377.6 |
| E′ (−40° C.)/10 Hz [MPa] | 97.56 | 114.3 | 188.7 | 165.6 | 104.2 | 137.1 | 144.1 | 115.6 |
| E′ (−30° C.)/10 Hz [MPa] | 50.70 | 57.11 | 86.87 | 73.83 | 53.97 | 65.19 | 67.23 | 59.07 |
| E′ (−20° C.)/10 Hz [MPa] | 31.81 | 36.16 | 48.78 | 43.65 | 35.08 | 38.42 | 41.01 | 37.08 |
| E′ (−10° C.)/10 Hz [MPa] | 22.60 | 25.78 | 31.71 | 29.51 | 25.7 | 27.19 | 28.84 | 25.25 |
| E′ (0° C.)/10 Hz [MPa] | 17.65 | 19.51 | 22.99 | 22.16 | 20.32 | 20.88 | 22.17 | 19.97 |
| E″ (60° C.) 10 Hz [MPa] | 0.77 | 0.89 | 0.95 | 0.92 | 0.97 | 0.91 | 0.94 | 0.88 |
| E′ (60° C.) 10 Hz [MPa] | 8.23 | 8.77 | 9.12 | 9.38 | 9.44 | 9.35 | 9.61 | 9.82 |
| tan δ (60° C.) | 0.093 | 0.102 | 0.104 | 0.098 | 0.103 | 0.097 | 0.098 | 0.09 |

In the 4th mixture series, the glass transition temperature of the rubber matrix is varied within the inventive range of −70.5° C. to −75.9° C., by varying the ratios of S-SBR, high-cis-1,4 BR and NR. The amount of natural rubber is varied from 15 to 40 phr. The high-cis BR types used are both Nd BR type (Buna® CB 24) and Co BR (Buna® CB 1203). The S-SBRs used are Buna® VSL 2525-0 M and Buna® VSL 5025-0 HM. In all rubber mixtures, the amount of microgel is kept constant (10 phr). In inventive examples 4.1* to 4.6*, an advantageous combination of properties with regard to reversion resistance, E′, tan δ and abrasion resistance is found. In noninventive examples 4.7 and 4.8 with natural rubber contents of 38 and 40 phr, reversion resistance (F_{25 min}.-Fₘₐₓ.) is inadequate.

5th Mixture Series

In the 5th mixture series, the amount of the BR gel is increased from 0 to 25 phr, while keeping a constant mixing ratio of the rubbers S-SBR, high-cis BR and NR. The calculated glass transition temperature of the rubber matrix in each example is −73.4° C. and is within the inventive range. Example 5.1 does not contain any microgel and is not inventive. Examples 5.2* to 5.8* with microgel additions of 5 to 25 phr are inventive.

TABLE 5.1
Glass transition temperature of the rubber matrix

| Compound No. | 5.1 | 5.2* | 5.3* | 5.4* | 5.5* | 5.6* | 5.7* | 5.8* |
|---|---|---|---|---|---|---|---|---|
| Buna ® VSL | 45 | 45 | 45 | 45 | 45 | 45 | 45 | 45 |
| 2525-0 M | | | | | | | | |
| Buna ® CB 24 | 35 | 35 | 35 | 35 | 35 | 35 | 35 | 35 |
| TSR/RSS 3 | 20 | 20 | 20 | 20 | 20 | 20 | 20 | 20 |
| DEFO 1000 | | | | | | | | |
| Matrix Tg [° C.] | −73.4 | −73.4 | −73.4 | −73.4 | −73.4 | −73.4 | −73.4 | −73.4 |

TABLE 5.2
1st mixing stage (internal mixer)

| | | | | | | | | |
|---|---|---|---|---|---|---|---|---|
| Compound No. | 5.1 | 5.2* | 5.3* | 5.4* | 5.5* | 5.6* | 5.7* | 5.8* |

Time of addition: 0 sec.

| | | | | | | | | |
|---|---|---|---|---|---|---|---|---|
| Buna ® VSL 2525-0 M | 45 | 45 | 45 | 45 | 45 | 45 | 45 | 45 |
| Buna ® CB 24 | 35 | 35 | 35 | 35 | 35 | 35 | 35 | 35 |
| TSR/RSS 3 DEFO 1000 | 20 | 20 | 20 | 20 | 20 | 20 | 20 | 20 |

Time of addition: 30 sec.

| | | | | | | | | |
|---|---|---|---|---|---|---|---|---|
| Ultrasil ® VN3 | 53 | 53 | 53 | 53 | 53 | 53 | 53 | 53 |
| BR microgel | 0 | 5 | 10 | 12.5 | 15.0 | 17.5 | 20.0 | 25.0 |
| Vulkanox ® HS/LG | 2.0 | 2.0 | 2.0 | 2.0 | 2.0 | 2.0 | 2.0 | 2.0 |
| Vulkanox ® 4020/LG | 1.0 | 1.0 | 1.0 | 1.0 | 1.0 | 1.0 | 1.0 | 1.0 |
| stearic acid | 1.0 | 1.0 | 1.0 | 1.0 | 1.0 | 1.0 | 1.0 | 1.0 |
| ozone wax | 2.0 | 2.0 | 2.0 | 2.0 | 2.0 | 2.0 | 2.0 | 2.0 |
| Si75 | 6.5 | 6.5 | 6.5 | 6.5 | 6.5 | 6.5 | 6.5 | 6.5 |

Time of addition: 90 sec.

| | | | | | | | | |
|---|---|---|---|---|---|---|---|---|
| Ultrasil ® 7000 GR | 27 | 27 | 27 | 27 | 27 | 27 | 27 | 27 |
| mineral oil | 20 | 20 | 20 | 20 | 30 | 30 | 30 | 30 |
| carbon black | 12 | 12 | 12 | 12 | 12 | 12 | 12 | 12 |

Time of addition: 150 sec.

| | | | | | | | | |
|---|---|---|---|---|---|---|---|---|
| zinc oxide | 2.5 | 2.5 | 2.5 | 2.5 | 2.5 | 2.5 | 2.5 | 2.5 |

Heating from 210 sec.

| | | | | | | | | |
|---|---|---|---|---|---|---|---|---|
| Maximum temperature [° C.] | 150 | 150 | 150 | 150 | 150 | 150 | 150 | 150 |
| Time at max. temperature [min.] | 6 | 6 | 6 | 6 | 6 | 6 | 6 | 6 |
| Cooling and | 24 | 24 | 24 | 24 | 24 | 24 | 24 | 24 |
| storage at 23° C. [h] | | | | | | | | |

TABLE 5.3
2nd mixing stage (internal mixer)

| Compound No. | 5.1 | 5.2* | 5.3* | 5.4* | 5.5* | 5.6* | 5.7* | 5.8* |
|---|---|---|---|---|---|---|---|---|
| Maximum temperature [° C.] | 150 | 150 | 150 | 150 | 150 | 150 | 150 | 150 |
| Time at max. temperature [min.] | 6 | 6 | 6 | 6 | 6 | 6 | 6 | 6 |
| Cooling on roller | <60 | <60 | <60 | <60 | <60 | <60 | <60 | <60 |

TABLE 5.4
3rd mixing stage (roller)

| Compound No. | 5.1 | 5.2* | 5.3* | 5.4* | 5.5* | 5.6* | 5.7* | 5.8* |
|---|---|---|---|---|---|---|---|---|
| sulphur | 2.0 | 2.0 | 2.0 | 2.0 | 2.0 | 2.0 | 2.0 | 2.0 |
| Vulkacit ® | 2.0 | 2.0 | 2.0 | 2.0 | 2.0 | 2.0 | 2.0 | 2.0 |
| NZ/EGC | | | | | | | | |
| Rhenogran ® | 2.5 | 2.5 | 2.5 | 2.5 | 2.5 | 2.5 | 2.5 | 2.5 |
| DPG-80 | | | | | | | | |
| Maximum tem- | 60 | 60 | 60 | 60 | 60 | 60 | 60 | 60 |
| perature [° C.] | | | | | | | | |

Using the unvulcanized rubber mixture, the Mooney viscosity and the Mooney relaxation after 10 and 30 sec were determined.

TABLE 5.5

| Compound No. | 5.1 | 5.2* | 5.3* | 5.4* | 5.5* | 5.6* | 5.7* | 5.8* |
|---|---|---|---|---|---|---|---|---|
| ML 1 + 1 (100° C.) [ME] | 91.6 | 94.2 | 95.4 | 100.9 | 102.1 | 103.8 | 110.9 | 117.6 |
| ML 1 + 4 (100° C.) [ME] | 78.0 | 81.7 | 83.2 | 88.4 | 90.5 | 92.6 | 99.1 | 107.1 |
| Mooney relaxation/10 sec. [%] | 23.9 | 24.6 | 24.6 | 26.0 | 26.2 | 26.3 | 28.4 | 30.0 |
| Mooney relaxation/30 sec. [%] | 18.5 | 19.2 | 19.0 | 20.5 | 20.6 | 20.6 | 22.8 | 24.6 |

The vulcanization characteristics of the mixtures were studied in a rheometer at 160° C. to DIN 53 529 with the aid of the MDR 2000E Monsanto rheometer.

TABLE 5.6

| Compound No. | 5.1 | 5.2* | 5.3* | 5.4* | 5.5* | 5.6* | 5.7* | 5.8* |
|---|---|---|---|---|---|---|---|---|
| F_{min.} [dNm] | 4.57 | 5.08 | 5.13 | 5.65 | 5.65 | 5.63 | 6.34 | 7.19 |
| Fₘₐₓ [dNm] | 24.09 | 23.32 | 24.09 | 24.38 | 24.17 | 24.06 | 24.57 | 24.85 |
| Fₘₐₓ − F_{min.} [dNm] | 19.52 | 18.24 | 18.96 | 18.73 | 18.52 | 18.43 | 18.23 | 17.66 |
| t₁₀ [sec] | 100 | 105 | 117 | 111 | 115 | 122 | 119 | 113 |
| t₅₀ [sec] | 160 | 162 | 181 | 173 | 178 | 190 | 185 | 194 |
| t₉₀ [sec] | 342 | 335 | 327 | 335 | 329 | 323 | 317 | 316 |
| t₉₅ [sec] | 453 | 450 | 420 | 441 | 430 | 408 | 410 | 392 |
| t₉₀-t₁₀ [sec] | 242 | 230 | 210 | 224 | 214 | 286 | 198 | 203 |
| F_{15 min.} [dNm] | 24.03 | 23.26 | 24.06 | 24.34 | 24.15 | 24.03 | 24.55 | 24.78 |
| F_{20 min.} [dNm] | 24.00 | 23.26 | 23.99 | 24.33 | 24.09 | 23.90 | 24.40 | 24.72 |
| F_{25 min.} [dNm] | 23.86 | 23.27 | 23.93 | 24.29 | 24.05 | 23.85 | 24.36 | 24.66 |
| F_{25 min} − Fₘₐₓ [dNm] | −0.23 | −0.05 | −0.16 | −0.09 | −0.12 | −0.21 | −0.21 | −0.19 |

The specimens needed for the vulcanizate characterization were produced by press vulcanization under the following conditions:

TABLE 5.7
Vulcanization time

| Compound No. | 5.1 | 5.2* | 5.3* | 5.4* | 5.5* | 5.6* | 5.7* | 5.8* |
|---|---|---|---|---|---|---|---|---|
| Temperature [° C.] | 160 | 160 | 160 | 160 | 160 | 160 | 160 | 160 |
| Time [min.] | 13 | 13 | 13 | 13 | 13 | 13 | 13 | 13 |

The vulcanizate properties are summarized in the table below

TABLE 5.8
Vulcanizate properties

| Compound No. | 5.1 | 5.2* | 5.3* | 5.4* | 5.5* | 5.6* | 5.7* | 5.8* |
|---|---|---|---|---|---|---|---|---|
| Shore A hardness at 23° C. DIN 53505 | 68.7 | 71.1 | 70.7 | 70.9 | 70.4 | 70.7 | 71.2 | 71.2 |
| Shore A hardness at 70° C. DIN 53505 | 66.2 | 66.8 | 66.0 | 66.5 | 66.0 | 64.5 | 65.7 | 65.5 |
| Resilience/23° C. DIN 53512 [%] [%] | 40.1 | 42.7 | 45.3 | 45.5 | 46.6 | 47.5 | 47.4 | 49.0 |
| Resilience/70° C. DIN 53512 [%] [%] | 55.0 | 56.3 | 58.9 | 58.6 | 59.2 | 60.4 | 60.7 | 61.1 |
| Compression set/70° C. [%] | 21.91 | 21.72 | 21.29 | 20.31 | 20.07 | 19.34 | 19.83 | 21.38 |
| σ₁₀ DIN 53504 [MPa] | 0.6 | 0.6 | 0.6 | 0.7 | 0.6 | 0.6 | 0.7 | 0.7 |
| σ₂₅ DIN 53504 [MPa] | 1.1 | 1.1 | 1.1 | 1.2 | 1.2 | 1.2 | 1.2 | 1.3 |
| σ₅₀ DIN 53504 [MPa] | 1.7 | 1.7 | 1.7 | 1.9 | 1.9 | 1.8 | 2.0 | 2.1 |
| σ₁₀₀ DIN 53504 [MPa] | 3.2 | 3.2 | 3.2 | 3.8 | 3.9 | 3.7 | 4.3 | 4.4 |
| σ₃₀₀ DIN 53504 [MPa] | 17.2 | 17.0 | 17.2 | — | — | — | — | — |
| σ₃₀₀/□σ₂₅ | 16.6 | 15.5 | 15.6 | — | — | — | — | — |
| Tensile strength DIN 53504 [MPa] | 18.4 | 17.7 | 19.2 | 18.8 | 15.8 | 17.7 | 17.8 | 17.1 |
| Elongation at break DIN 53504 [MPa] | 313 | 307 | 324 | 297 | 254 | 284 | 269 | 271 |
| Abrasion DIN 53516 [mm3] | 51 | 48 | 49 | 46 | 49 | 45 | 46 | 44 |

TABLE 5.9
Temperature dependence of E′/Eplexor test* (heating rate: 1 K/min)

| Compound No. | 5.1 | 5.2* | 5.3* | 5.4* | 5.5* | 5.6* | 5.7* | 5.8* |
|---|---|---|---|---|---|---|---|---|
| E′ (−60° C.)/10 Hz [MPa] | 1209 | 1202 | 1163 | 1184 | 1111 | 1142 | 1112 | 989 |
| E′ (−50° C.)/10 Hz [MPa] | 435.4 | 423.2 | 370.8 | 387.5 | 320.8 | 350.8 | 319.4 | 291.1 |
| E′ (−40° C.)/10 Hz [MPa] | 149.1 | 146.4 | 130.5 | 121.3 | 112.4 | 113.9 | 100.1 | 94.0 |
| E′ (−30° C.)/10 Hz [MPa] | 75.24 | 71.15 | 63.26 | 57.09 | 55.91 | 55.81 | 47.17 | 47.52 |
| E′ (−20° C.)/10 Hz [MPa] | 47.59 | 44.59 | 39.95 | 36.53 | 35.26 | 35.64 | 29.94 | 31.09 |
| E′ (−10° C.)/10 Hz [MPa] | 32.67 | 30.86 | 28.58 | 24.17 | 25.30 | 25.43 | 21.28 | 22.67 |
| E′ (0° C.)/10 Hz [MPa] | 26.03 | 23.98 | 22.51 | 18.91 | 19.37 | 18.88 | 16.84 | 18.22 |
| E″ (60° C.) 10 Hz [MPa] | 1.18 | 1.16 | 1.04 | 0.96 | 0.93 | 0.93 | 0.78 | 0.84 |
| E′ (60° C.) 10 Hz [MPa] | 10.74 | 10.37 | 10.32 | 9.62 | 9.67 | 10.28 | 9.11 | 9.88 |
| tan δ (60° C.) | 0.110 | 0.109 | 0.101 | 0.10 | 0.096 | 0.091 | 0.086 | 0.085 |

In the 5th mixture series, the amount of BR gel in the rubber mixture is varied from 0 to 25 parts by weight, while keeping a constant mixing ratio of solution SBR, 1,4-cis-polybutadiene and NR. The glass transition temperature of the rubber matrix in all examples is −73.4° C. The 5th mixture series shows that, given satisfactory reversion resistance, the additions of BR gel improve the temperature dependence of the storage modulus E′ within the temperature range of −60° C. to −10° C., tan δ (60° C.) and the DIN abrasion. For this reason, examples 5.2* to 5.8* are inventive.

6th Mixture Series

In the noninventive 6th mixture series, the amount of the BR gel is increased from 0 to 30 phr, while keeping a constant mixing ratio of the rubbers S-SBR, high-cis BR and NR. The calculated glass transition temperature of the rubber matrix in all examples is −60.8° C. and is within the noninventive range. Examples 6.1 to 6.7 are noninventive examples.

TABLE 6.1
Glass transition temperature of the rubber matrix

| Compound No. | 6.1 | 6.2 | 6.3 | 6.4 | 6.5 | 6.6 | 6.7 |
|---|---|---|---|---|---|---|---|
| Buna ® VSL 5025-1 HM | 61.88 | 61.88 | 61.88 | 61.88 | 61.88 | 61.88 | 61.88 |
| Buna ® CB 24 | 35 | 35 | 35 | 35 | 35 | 35 | 35 |
| TSR/RSS 3 DEFO 1000 | 20 | 20 | 20 | 20 | 20 | 20 | 20 |
| Matrix Tg [° C.] | −60.8 | −60.8 | −60.8 | −60.8 | −60.8 | −60.8 | −60.8 |

TABLE 6.2
1st mixing stage

| | | | | | | | |
|---|---|---|---|---|---|---|---|
| Compound No. | 6.1 | 6.2 | 6.3 | 6.4 | 6.5 | 6.6 | 6.7 |

Time of addition: 0 sec.

| | | | | | | | |
|---|---|---|---|---|---|---|---|
| Buna ® VSL 5025-1 HM | 61.88 | 61.88 | 61.88 | 61.88 | 61.88 | 61.88 | 61.88 |
| Buna ® CB 24 | 35 | 35 | 35 | 35 | 35 | 35 | 35 |
| TSR/RSS 3 DEFO 1000 | 20 | 20 | 20 | 20 | 2.0 | 20 | 20 |

Time of addition: 60 sec.

| | | | | | | | |
|---|---|---|---|---|---|---|---|
| Ultrasil ® 7000 GR | 80 | 80 | 80 | 80 | 80 | 80 | 80 |
| Si69 | 6.5 | 6.5 | 6.5 | 6.5 | 6.5 | 6.5 | 6.5 |
| carbon black | 5 | 5 | 5 | 5 | 5 | 5 | 5 |
| BR microgel | 0 | 5 | 10 | 15 | 20 | 25 | 30 |

Heating: 65-90 sec.

| | | | | | | | |
|---|---|---|---|---|---|---|---|
| Maximum temperature [° C.] | 140 | 140 | 140 | 140 | 140 | 140 | 140 |
| Time at max. temperature [sec.] | 120 | 120 | 120 | 120 | 120 | 120 | 120 |

Time of addition: 210 sec.

| | | | | | | | |
|---|---|---|---|---|---|---|---|
| mineral oil | 20 | 2.0 | 20 | 20 | 20 | 20 | 20 |
| Vulkanox ® HS/LG | 2.0 | 2.0 | 2.0 | 2.0 | 2.0 | 2.0 | 2.0 |
| Vulkanox ® 4020/LG | 1.0 | 1.0 | 1.0 | 1.0 | 1.0 | 1.0 | 1.0 |
| ozone wax | 2.0 | 2.0 | 2.0 | 2.0 | 2.0 | 2.0 | 2.0 |
| stearic acid | 1.0 | 1.0 | 1.0 | 1.0 | 1.0 | 1.0 | 1.0 |
| zinc oxide | 2.5 | 2.5 | 2.5 | 2.5 | 2.5 | 2.5 | 2.5 |
| Rhenogran ® DPG-80 | 2.5 | 2.5 | 2.5 | 2.5 | 2.5 | 2.5 | 2.5 |

Ejection 300 sec.

| | | | | | | | |
|---|---|---|---|---|---|---|---|
| Cooling and storage at 23° C. [h] | 24 | 24 | 24 | 24 | 24 | 24 | 24 |

TABLE 6.3
2nd mixing stage

| Compound No. | 6.1 | 6.2 | 6.3 | 6.4 | 6.5 | 6.6 | 6.7 |
|---|---|---|---|---|---|---|---|
| Maximum temperature | 140 | 140 | 140 | 140 | 140 | 140 | 140 |
| [° C.] | | | | | | | |
| Time at max. tempera- | 120 | 120 | 120 | 120 | 120 | 120 | 120 |
| ture [min.] | | | | | | | |
| Cooling on roller [° C.] | <60 | <60 | <60 | <60 | <60 | <60 | <60 |

TABLE 6.4
3rd mixing stage (roller)

| Compound No. | 6.1 | 6.2 | 6.3 | 6.4 | 6.5 | 6.6 | 6.7 |
|---|---|---|---|---|---|---|---|
| sulphur | 2.0 | 2.0 | 2.0 | 2.0 | 2.0 | 2.0 | 2.0 |
| Vulkacit ® NZ/EGC | 2.0 | 2.0 | 2.0 | 2.0 | 2.0 | 2.0 | 2.0 |
| DPG ¹⁵⁾ | 2.0 | 2.0 | 2.0 | 2.0 | 2.0 | 2.0 | 2.0 |
| Maximum temperature | 60 | 60 | 60 | 60 | 60 | 60 | 60 |
| [° C.] | | | | | | | |

Using the unvulcanized rubber mixture, the Mooney viscosity and the Mooney relaxation after 10 and 30 sec were determined.

TABLE 6.5
Properties of unvulcanized mixtures

| Compound No. | 6.1 | 6.2 | 6.3 | 6.4 | 6.5 | 6.6 | 6.7 |
|---|---|---|---|---|---|---|---|
| ML 1 + 1 (100° C.) | 70.2 | 76.6 | 75.1 | 84.1 | 89.4 | 91.8 | 99.2 |
| [ME] | | | | | | | |
| ML 1 + 4 (100° C.) | 67.1 | 65.9 | 65.8 | 74.8 | 80.4 | 83.1 | 90.0 |
| [ME] | | | | | | | |
| Mooney relaxation/ | 21.5 | 19.7 | 18.9 | 20.1 | 21.7 | 22.2 | 24.1 |
| 10 sec. [%] | | | | | | | |
| Mooney relaxation/ | 15.7 | 14.1 | 13.3 | 14.6 | 16.1 | 16.8 | 18.7 |
| 30 sec. [%] | | | | | | | |

The vulcanization characteristics of the mixtures are studied in a rheometer at 160° C. to DIN 53 529 with the aid of the MDR 2000E Monsanto rheometer.

TABLE 6.6
Vulcanization characteristics

| Compound No. | 6.1 | 6.2 | 6.3 | 6.4 | 6.5 | 6.6 | 6.7 |
|---|---|---|---|---|---|---|---|
| F_{min.} [dNm] | 2.53 | 3.00 | 3.23 | 4.47 | 4.81 | 5.60 | 5.18 |
| Fₘₐₓ [dNm] | 22.94 | 22.84 | 21.65 | 22.48 | 21.68 | 21.36 | 20.71 |
| Fₘₐₓ − F_{min.} [dNm] | 20.41 | 19.84 | 18.42 | 18.01 | 16.87 | 15.76 | 15.53 |
| t₁₀ [sec] | 95 | 103 | 112 | 135 | 131 | 161 | 76 |
| t₅₀ [sec] | 211 | 226 | 238 | 270 | 274 | 300 | 300 |
| t₉₀ [sec] | 402 | 409 | 434 | 493 | 471 | 516 | 519 |
| t₉₅ [sec] | 526 | 538 | 568 | 642 | 609 | 666 | 668 |
| t₉₀-t₁₀ [sec] | 307 | 06 | 322 | 358 | 340 | 355 | 443 |
| F_{15 min.} [dNm] | 22.87 | 22.75 | 21.54 | 22.24 | 21.51 | 21.12 | 20.47 |
| F_{20 min.} [dNm] | 22.91 | 22.82 | 21.64 | 22.46 | 21.66 | 21.33 | 20.67 |
| F_{25 min.} [dNm] | 22.75 | 22.71 | 21.56 | 22.44 | 21.64 | 21.33 | 20.69 |
| F_{25 min} − Fₘₐₓ [dNm] | −0.19 | −0.13 | −0.09 | −0.04 | −0.04 | −0.03 | −0.02 |

The specimens needed for the vulcanizate characterization were produced by press vulcanization under the following conditions:

TABLE 6.7
Vulcanization time

| Compound No. | 6.1 | 6.2 | 6.3 | 6.4 | 6.5 | 6.6 | 6.7 |
|---|---|---|---|---|---|---|---|
| Temperature [° C.] | 160 | 160 | 160 | 160 | 160 | 160 | 160 |
| Time [min.] | 30 | 30 | 30 | 30 | 30 | 30 | 30 |

The vulcanizate properties are summarized in the table below

TABLE 6.8
Vulcanizate properties

| Compound No. | 6.1 | 6.2 | 6.3 | 6.4 | 6.5 | 6.6 | 6.7 |
|---|---|---|---|---|---|---|---|
| Shore A hardness at 23° C. DIN 53505 | 66.4 | 65.9 | 64.3 | 64.7 | 64.5 | 64 | 63.3 |
| Shore A hardness at 70° C. DIN 53505 | 65.3 | 65.1 | 63.6 | 64.6 | 64.2 | 63.4 | 62.9 |
| Resilience/0° C. DIN 53512 [%] [%] | | | | | | | |
| Resilience/23° C. DIN 53512 [%] [%] | 39 | 42 | 44 | 46 | 47 | 49 | 51 |
| Resilience/70° C. DIN 53512 [%] [%] | 60 | 62 | 63 | 63 | 64 | 65 | 65 |
| σ₁₀ DIN 53504 [MPa] | 0.6 | 0.6 | 0.5 | 0.5 | 0.5 | 0.5 | 0.5 |
| σ₂₅ DIN 53504 [MPa] | 1.0 | 1.0 | 0.9 | 0.9 | 0.9 | 0.9 | 0.9 |
| σ₅₀ DIN 53504 [MPa] | 1.4 | 1.4 | 1.4 | 1.4 | 1.4 | 1.4 | 1.4 |
| σ₁₀₀ DIN 53504 [MPa] | 2.6 | 2.6 | 2.5 | 2.7 | 2.7 | 2.7 | 2.8 |
| σ₃₀₀ DIN 53504 [MPa] | 12.1 | 12.7 | 12.4 | 11.9 | 12.3 | 11.8 | 11.5 |
| σ₃₀₀/σ₂₅ | 12.1 | 12.7 | 13.7 | 13.2 | 13.6 | 13.1 | 12.7 |
| Tensile strength DIN 53504 [MPa] | 18.1 | 18.4 | 20.3 | 18.6 | 19.6 | 17.7 | 18.4 |
| Elongation at break DIN 53504 [MPa] | 407 | 395 | 441 | 432 | 437 | 427 | 458 |
| Abrasion DIN 53516 [mm3] | 85 | 80 | 77 | 73 | 73 | 75 | 78 |

TABLE 6.9
Temperature dependence of E′/Eplexor test* (heating rate: 1 K/min)

| Compound No. | 5.1 | 6.1 | 6.2 | 6.3 | 6.4 | 6.5 | 6.6 |
|---|---|---|---|---|---|---|---|
| E′ (−60° C.)/10 Hz [MPa] | 1833 | 1693 | 1632 | 1509 | 1757 | 1426 | 1329 |
| E′ (−50° C.)/10 Hz [MPa] | 1066 | 923 | 898 | 869 | 867 | 713 | 702 |
| E′ (−40° C.)/10 Hz [MPa] | 457 | 381 | 366 | 349 | 322 | 264 | 237 |
| E′ (−30° C.)/10 Hz [MPa] | 175 | 144 | 133 | 128 | 109 | 92 | 77 |
| E′ (−20° C.)/10 Hz [MPa] | 83 | 67 | 62 | 58 | 48 | 41 | 33 |
| E′ (−10° C.)/10 Hz [MPa] | 50 | 41 | 37 | 35 | 29 | 25 | 20 |
| E′ (0° C.)/10 Hz [MPa] | 35.2 | 28.7 | 26.2 | 25.3 | 20.4 | 17.5 | 14.5 |
| tan δ (60° C.) | 0.093 | 0.086 | 0.082 | 0.078 | 0.073 | 0.069 | 0.069 |

In the noninventive 6th mixture series, the amount of the BR gel is increased from 0 to 30 phr, while keeping a constant mixing ratio of the rubbers S-SBR, high-cis BR and NR. The glass transition temperature of the rubber matrix in all examples is −60.8° C. and is within the noninventive range. Particularly the DIN abrasion values are unsatisfactory for all examples of the 6th mixture series.

What is claimed is:

1. Vulcanizable rubber mixtures comprising at least the following components:
I.) 100 parts by weight of an oil-free rubber matrix consisting of
a) 15 to 79 parts by weight, preferably 20 to 70 parts by weight, of at least one solution SBR (S-SBR) (oil-free) having a glass transition temperature (Tg_{(S-SBR)}) between −70° C. and −10° C.,
b) 20 to 75 parts by weight, preferably 25 to 70 parts by weight, of at least one 1,4-cis-polybutadiene (BR) (oil-free) having a glass transition temperature (Tg_{(BR)}) between −95° C. and −115° C.,
c) 1 to 37.5 parts by weight, preferably 5 to 35 parts by weight, of natural rubber (NR) (oil-free) and/or at least one synthetic polyisoprene (IR) (oil-free) having a glass transition temperature (Tg_{(NR)}) between −50° C. and −75° C.,
II.) at least one hydroxyl-containing microgel based on polybutadiene,
III.) at least one hydroxyl-containing, oxidic filler,
IV.) at least one polysulphide-containing alkoxysilane,
V.) at least one vulcanizing agent,
VI.) optionally at least one rubber additive.

2. Vulcanizable rubber mixtures according to claim 1, characterized in that the oil-free rubber matrix I.) has a glass transition temperature (Tg₍ₘₐₜᵣᵢₓ₎) between −70° C. and −90° C., the Tg_{(Matrix)} being calculated by the general equation
Tg₍ₘₐₜᵣᵢₓ₎=X_{(BR)}×Tg_{(BR)}+X_{(S-SBR)}×Tg_{(S-SBR)}+X_{(NR)}×Tg_{(NR)}
where

| | |
|---|---|
| glass transition temperature of the rubber matrix (oil-free) | Tg₍ₘₐₜᵣᵢₓ₎ |
| parts by weight of 1,4-cis-polybutadiene (oil-free) | X_{(BR)} |
| parts by weight of S-SBR(oil-free) | X_{(S-SBR)} |
| parts by weight of NR or IR (oil-free) | X_{(NR)} |
| glass transition temperature of 1,4-cis-polybutadiene (oil-free) | Tg_{(BR)} |
| glass ransition temperature of S-SBR (oil-free) | Tg_{(S-SBR)} |
| glass transition temperature of NR or IR (oil-free) | Tg_{(NR)}. |

3. Vulcanizable rubber mixtures according to claim 2, characterized in that the solution SBR has a Mooney viscosity (ML 1+4 at 100° C.) of 20 to 150 Mooney units, preferably of 30 to 100 Mooney units.

4. Vulcanizable rubber mixtures according to claim 2, characterized in that the 1,4-cis-polybutadiene has a 1,4-cis content of at least 90 mol %.

5. Vulcanizable rubber mixtures according to claim 4, characterized in that the 1,4-cis-polybutadiene is Ti—BR, Co—BR, Ni—BR or Nd—BR.

6. Vulcanizable rubber mixtures according to claim 2, characterized in that the polyisoprene has a 1,4-cis content of at least 70 mol %.

7. Vulcanizable rubber mixtures according to claim 2, characterized in that the hydroxyl-containing microgel II.) has a glass transition temperature (Tg_{(MICROGEL)}) between −82° C. and −60° C., preferably −65° C. and −82° C., especially preferably −70° C. and −80° C.

8. Vulcanizable rubber mixtures according to claim 2, characterized in that 1 to 50 parts by weight, preferably 2.5 to 30 parts by weight, more preferably 5 to 20 parts by weight, based on 100 parts by weight of oil-free rubber matrix, of the hydroxyl-containing microgel II.) are used.

9. Vulcanizable rubber mixtures according to claim 8, characterized in that the hydroxyl-containing microgel has a gel content of more than 70% by weight, preferably more than 75% by weight, especially preferably more than 80% by weight.

10. Vulcanizable rubber mixtures according to claim 9, characterized in that the hydroxyl-containing microgel has a swelling index (Qi) in toluene of less than 30, preferably less than 25, especially preferably less than 20.

11. Vulcanizable rubber mixtures according to claim 10, characterized in that the hydroxyl-containing microgel has a particle size of 10 to 100 nm.

12. Vulcanizable rubber mixtures according to claim 2, characterized in that the hydroxyl-containing, oxidic filler III.) is silica, the content thereof being in the range of 10 up to 150 parts by weight, preferably in the range of 20 to 120 parts by weight, and more preferably 25 to 100 parts by weight, based on 100 parts by weight of oil-free rubber matrix.

13. Vulcanizable rubber mixtures according to claim 2, characterized in that the polysulphide-containing alkoxysilane is of the general formula (1) or (2)
Z-A-Sₓ-A-Z (1)
Z-A-S_{y}—R³ (2)
in which
x is an integer of 2 to 8,
y is an integer of 1 to 8,
A are the same or different and are each a divalent hydrocarbon group (“spacer”)
Z are the same or different and have one of the following formulae: 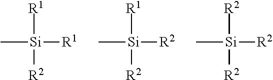
in which
R¹ are the same or different, may be substituted or unsubstituted and are each a C₁-C₁₈ alkyl group, a C₅-C₁₈ cycloalkyl group or C₆-C₁₈ aryl group and
R² are the same or different, may be substituted or unsubstituted and are each a C₁-C₁₈ alkoxy group, a C₅-C₁₈ cycloalkoxy group or C₆-C₁₈ aryloxy group and
and
R³ is hydrogen, straight-chain or branched alkyl, where the alkyl chain may optionally be interrupted by one or more, preferably up to five heteroatoms, especially oxygen, sulphur or N(H), aryl, preferably C₆-C₂₀-Aryl and/or a radical having the following structures: 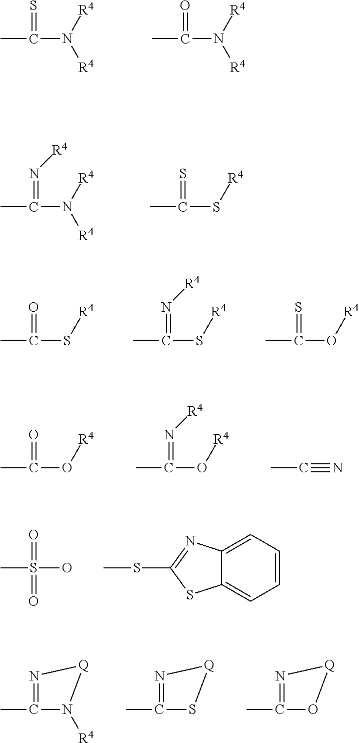
in which R⁴ is an aliphatic, heteroaliphatic, cycloaliphatic, aromatic or heteroaromatic radical having 1 to 20, preferably 1 to 10, carbon atoms and having optionally 1 to 3 heteroatoms, preferably oxygen, nitrogen or sulphur.

14. Vulcanizable rubber mixtures according to claim 13, characterized in that 0.2 to 12 parts by weight, preferably 1 to 10 parts by weight, based on 100 parts by weight of oil-free rubber matrix, of polysulphide-containing alkoxysilane are used.

15. Vulcanizable rubber mixtures according to claim 1, characterized in that they do not comprise any polythiophosphorus compounds.

16. Process for producing vulcanizable rubber mixtures according to claim 1, characterized in that components I.) to VI.) are mixed with one another in one or more stages, preferably by a three-stage mixing operation with two mixing stages in an internal mixer and a final mixing stage on a miler, or by a two-stage mixing operation in which the 1st mixing stage is effected in an internal mixer and the 2nd mixing stage on a roller, or by a two-stage mixing operation in which both mixing stages are effected in an internal mixer, the mixture being cooled prior to addition of those components which are added on the roller in the three-stage mixing operation to temperatures of <120° C., preferably <110° C.

17. Process for producing vulcanizates, characterized in that vulcanizable rubber mixtures according to claim 1 are subjected to a crosslinking reaction, preferably at a temperature in the range of 100 to 250° C., especially 130 to 180° C., under a pressure in the range of 1 to 200 bar.

18. Process according to claim 17, characterized in that the crosslinking takes place in the course of a shaping operation.

19. Vulcanizates obtainable by the process according to claim 17.

20. Use of vulcanizable rubber mixtures according to any of claim 1 for production of pneumatic tyres, especially winter tyres, tyre components, especially tyre treads, especially treads of winter tyres, subtreads, carcasses, sidewalls, reinforced sidewalls for runflat tyres and apex mixtures, and for the production of industrial rubber articles, preferably damping elements, roll coverings, conveyor belt coverings, drive belts, spinning cops, seals, golfball cores and shoe soles.
